(19) United States
(12) Patent Application Publication
(10) Pub. No.: US 2025/0350513 A1
(43) Pub. Date: Nov. 13, 2025

(54) BANDWIDTH PART (BWP)-AWARE DYNAMIC FREQUENCY SHIFT TO MITIGATE NOISE FIGURE (NF) DEGRADATION

(71) Applicant: QUALCOMM Incorporated, San Diego, CA (US)

(72) Inventors: Srinivas PACHAVA, Hyderabad (IN); Saranyan NAGARAJAN, Hyderabad (IN); Aditya MANDAPAKA, Hyderabad (IN); Bhaskar Narayana Murthy DIVAKARLA, Hyderabad (IN); Parthiban RAJENDRAN, Hyderabad (IN); Karthik DUMPALA, Hyderabad (IN); Sriramgopal SRIDHARA, San Diego, CA (US); Ehab ABDEL GHANY, San Diego, CA (US); Mahim RANJAN, San Diego, CA (US)

(21) Appl. No.: 18/662,853

(22) Filed: May 13, 2024

(51) Int. Cl. H04L 27/00; H04B 1/00

(52) U.S. Cl. CPC H04L 27/0014; H04B 1/0075

(57) ABSTRACT

Certain aspects of the present disclosure are directed towards methods and apparatus for wireless communication. An example method generally includes: comparing a page local oscillator (LO) frequency for page reception using a first subscriber and data traffic LO frequencies of respective bandwidth parts (BWPs) for data traffic reception using a second subscriber; determining a frequency offset to be applied to the page LO frequency or one or more of the data traffic LO frequencies based on the comparison of the page LO frequency and the data traffic LO frequencies; and performing frequency tuning of the page LO frequency or the one or more of the data traffic LO frequencies based on the frequency offset.

### TECHNICAL FIELD

Certain aspects of the present disclosure generally relate to wireless communication and, more particularly, to techniques for performing dynamic frequency shifts.

### BACKGROUND

Wireless communication devices are widely deployed to provide various communication services such as telephony, video, data, messaging, broadcasts, and so on. Such wireless communication devices may transmit and/or receive radio frequency (RF) signals via any of various suitable radio access technologies (RATs) including, but not limited to, Fifth Generation (5G) New Radio (NR), Long Term Evolution (LTE), Code Division Multiple Access (CDMA), Time Division Multiple Access (TDMA), Wideband CDMA (WCDMA), Global System for Mobility (GSM), Bluetooth, Bluetooth Low Energy (BLE), ZigBee, wireless local area network (WLAN) RATs (e.g., WiFi), and the like.

A wireless communication network may include a number of base stations that can support communication for a number of mobile stations. A mobile station (MS) may communicate with a base station (BS) via a downlink and an uplink. The downlink (or forward link) refers to the communication link from the base station to the mobile station, and the uplink (or reverse link) refers to the communication link from the mobile station to the base station. A base station may transmit data and control information on the downlink to a mobile station and/or may receive data and control information on the uplink from the mobile station. The base station and/or mobile station may include one or more frequency synthesizers that generate local oscillator (LO) signals for down-conversion or up-conversion of signals.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide advantages that include reduced noise.

Certain aspects are directed towards a method for wireless communication. The method generally includes: comparing a page local oscillator (LO) frequency for page reception using a first subscriber and data traffic LO frequencies of respective bandwidth parts (BWPs) for data traffic reception using a second subscriber; determining a frequency offset to be applied to the page LO frequency or one or more of the data traffic LO frequencies based on the comparison of the page LO frequency and the data traffic LO frequencies; and performing frequency tuning of the page LO frequency or the one or more of the data traffic LO frequencies based on the frequency offset.

Certain aspects are directed towards an apparatus for wireless communication. The apparatus generally includes one or more memories collectively storing executable instructions and one or more processors coupled to the one or more memories, the one or more processors being collectively configured to execute the executable instructions to cause the apparatus to: compare a page local oscillator (LO) frequency for page reception using a first subscriber and data traffic LO frequencies of respective bandwidth parts (BWPs) for data traffic reception using a second subscriber; determine a frequency offset to be applied to the page LO frequency or one or more of the data traffic LO frequencies based on the comparison of the page LO frequency and the data traffic LO frequencies; and perform frequency tuning of the page LO frequency or the one or more of the data traffic LO frequencies based on the frequency offset.

Certain aspects are directed towards a non-transitory computer-readable medium having instructions stored thereon, that when executed by one or more processors, cause the one or more processors to: compare a page local oscillator (LO) frequency for page reception using a first subscriber and data traffic LO frequencies of respective bandwidth parts (BWPs) for data traffic reception using a second subscriber; determine a frequency offset to be applied to the page LO frequency or one or more of the data traffic LO frequencies based on the comparison of the page LO frequency and the data traffic LO frequencies; and perform frequency tuning of the page LO frequency or the one or more of the data traffic LO frequencies based on the frequency offset.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in which aspects of the present disclosure may be practiced.

FIG. 2 is a block diagram conceptually illustrating a design of an example base station (BS) and user equipment (UE), in which aspects of the present disclosure may be practiced.

FIG. 3 is a block diagram of an example radio frequency (RF) transceiver, in which aspects of the present disclosure may be practiced.

FIG. 4 illustrates a downlink pipe (DLP) including a primary receive path (PRx) and a diversity receive path (DRx).

FIGS. 5A, 5B, and 5C illustrate different scenarios of example local oscillator (LO) frequencies for two subscribers.

FIG. 6A illustrates example techniques for implementing a low intermediate frequency (LIF) offset, in accordance with certain aspects of the present disclosure.

FIG. 6B illustrates a transceiver with or without a low noise amplifier (LNA) outside the transceiver.

FIG. 7 is a graph illustrating four bandwidth parts (BWPs) associated with different LO frequencies.

FIG. 8 is a graph illustrating candidate page LO frequencies that may overlap with LO frequencies of BWPs.

FIG. 9 is a diagram illustrating timing of page and data traffic receptions.

FIGS. 10A-10D are graphs illustrating page and BWP LO frequencies and a LIF offset calculated for one or more of the BWP LO frequencies, in accordance with certain aspects of the present disclosure.

FIG. 11A is a flow diagram illustrating example operations for determining a LIF offset for BWPs, in accordance with certain aspects of the present disclosure.

FIG. 11B provides example frequency values for BWPs and page signaling, in accordance with certain aspects of the present disclosure.

FIG. 12 is a diagram illustrating timing of page and data traffic receptions.

FIGS. 13A-13N are graphs illustrating page and BWP LO frequencies and LIF offset determined for a page LO frequency, in accordance with certain aspects of the present disclosure.

FIG. 14 is a flow diagram illustrating example operations for determining a LIF offset for a page LO frequency, in accordance with certain aspects of the present disclosure.

FIG. 15 provides example frequency values for BWPs and page signaling, in accordance with certain aspects of the present disclosure.

FIG. 16 illustrates example operations for application of a LIF offset, in accordance with certain aspects of the present disclosure.

FIG. 17 is a flow diagram illustrating example operations for wireless communication, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure are directed toward dynamic frequency shifting of a local oscillator (LO) signal to improve noise figure (NF) performance. Dynamic frequency shifting may be used to separate frequencies of LO signals for different subscribers. The frequency shifting may be implemented by shifting the frequency of an LO signal of one of the subscribers, which may also be referred to as a low intermediate frequency (LIF) offset. For example, a wireless device may dynamically switch between zero intermediate frequency (IF) and LIF based on separation between LO subscriber frequencies. In some cases, data traffic may be received via one or multiple bandwidth parts (BWPs). In some aspects of the present disclosure, the LIF offset may be calculated for the multiple bandwidth parts (BWPs) that may be used for reception of data traffic, as described in more detail herein.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Wireless System

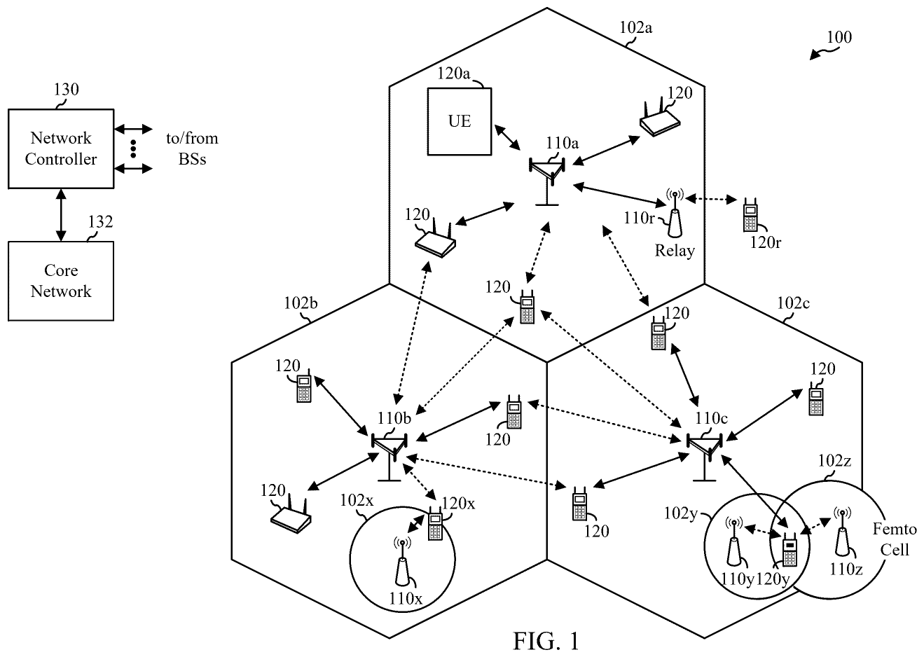

FIG. 1 illustrates an example wireless communications network 100, in which aspects of the present disclosure may be practiced. For example, the wireless communications network 100 may be a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation/Third Generation (2G/3G) network), or a code division multiple access (CDMA) system (e.g., a 2G/3G network), or may be configured for communications according to an IEEE standard such as one or more of the 802.11 standards, etc.

As illustrated in FIG. 1, the wireless communications network 100 may include a number of base stations (BSs) 110a-z (each also individually referred to herein as “BS 110” or collectively as “BSs 110”) and other network entities. A BS may also be referred to as an access point (AP), an evolved Node B (eNodeB or eNB), a next generation Node B (gNodeB or gNB), or some other terminology.

A BS 110 may provide communication coverage for a particular geographic area, sometimes referred to as a “cell,” which may be stationary or may move according to the location of a mobile BS. In some examples, the BSs 110 may be interconnected to one another and/or to one or more other BSs or network nodes (not shown) in wireless communications network 100 through various types of backhaul interfaces (e.g., a direct physical connection, a wireless connection, a virtual network, or the like) using any suitable transport network. In the example shown in FIG. 1, the BSs 110a, 110b, and 110c may be macro BSs for the macro cells 102a, 102b, and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with one or more user equipment's (UEs) 120a-y (each also individually referred to herein as “UE 120” or collectively as “UEs 120”) in the wireless communications network 100. A UE may be fixed or mobile and may also be referred to as a user terminal (UT), a mobile station (MS), an access terminal, a station (STA), a client, a wireless device, a mobile device, or some other terminology. A user terminal may be a wireless device, such as a cellular phone, a smartphone, a personal digital assistant (PDA), a handheld device, a wearable device, a wireless modem, a laptop computer, a tablet, a personal computer, etc.

The BSs 110 are considered transmitting entities for the downlink and receiving entities for the uplink. The UEs 120 are considered transmitting entities for the uplink and receiving entities for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink. Nup UEs may be selected for simultaneous transmission on the uplink, Nan UEs may be selected for simultaneous transmission on the downlink. Nup may or may not be equal to Nan, and Nup and Nan may be static values or can change for each scheduling interval. Beam-steering or some other spatial processing technique may be used at the BSs 110 and/or UEs 120.

The UEs 120 (e.g., 120x, 120y, etc.) may be dispersed throughout the wireless communications network 100, and each UE 120 may be stationary or mobile. The wireless communications network 100 may also include relay stations (e.g., relay station 110r), also referred to as relays or the like, that receive a transmission of data and/or other information from an upstream station (e.g., a BS 110a or a UE 120r) and send a transmission of the data and/or other information to a downstream station (e.g., a UE 120 or a BS 110), or that relays transmissions between UEs 120, to facilitate communication between devices.

The BSs 110 may communicate with one or more UEs 120 at any given moment on the downlink and uplink. The downlink (i.e., forward link) is the communication link from the BSs 110 to the UEs 120, and the uplink (i.e., reverse link) is the communication link from the UEs 120 to the BSs 110. A UE 120 may also communicate peer-to-peer with another UE 120.

The wireless communications network 100 may use multiple transmit and multiple receive antennas for data transmission on the downlink and uplink. BSs 110 may be equipped with a number Nap of antennas to achieve transmit diversity for downlink transmissions and/or receive diversity for uplink transmissions. A set Nu of UEs 120 may receive downlink transmissions and transmit uplink transmissions. Each UE 120 may transmit user-specific data to and/or receive user-specific data from the BSs 110. In general, each UE 120 may be equipped with one or multiple antennas. The Nu UEs 120 can have the same or different numbers of antennas.

The wireless communications network 100 may be a time division duplex (TDD) system or a frequency division duplex (FDD) system. For a TDD system, the downlink and uplink share the same frequency band. For an FDD system, the downlink and uplink use different frequency bands. The wireless communications network 100 may also utilize a single carrier or multiple carriers for transmission. Each UE 120 may be equipped with a single antenna (e.g., to keep costs down) or multiple antennas (e.g., where the additional cost can be supported).

A network controller 130 (also sometimes referred to as a “system controller”) may be in communication with a set of BSs 110 and provide coordination and control for these BSs 110 (e.g., via a backhaul). In certain cases (e.g., in a 5G NR system), the network controller 130 may include a centralized unit (CU) and/or a distributed unit (DU). In certain aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

In certain aspects of the present disclosure, the BSs 110 and/or the UEs 120 may include a transceiver implemented with a low intermediate frequency (LIF) offset to improve receiver NF, as described in more detail herein.

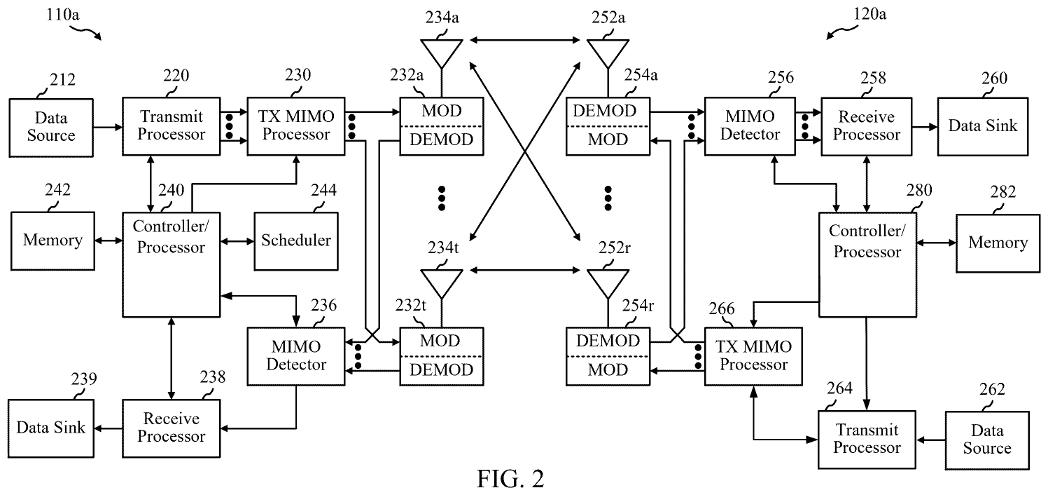

FIG. 2 illustrates example components of BS 110a and UE 120a (e.g., from the wireless communications network 100 of FIG. 1), in which aspects of the present disclosure may be implemented.

On the downlink, at the BS 110a, a transmit processor 220 may receive data from a data source 212, control information from a controller/processor 240, and/or possibly other data (e.g., from a scheduler 244). The various types of data may be sent on different transport channels. For example, the control information may be designated for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), etc. The data may be designated for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS).

A transmit (TX) multiple-input, multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for orthogonal frequency division multiplexing (OFDM), etc.) to obtain an output sample stream. Each of the transceivers 232a-232t may further process (e.g., convert to analog, amplify, filter, and upconvert) the output sample stream to obtain a downlink signal. Downlink signals from the transceivers 232a-232t may be transmitted via the antennas 234a-234t, respectively.

At the UE 120a, the antennas 252a-252r may receive the downlink signals from the BS 110a and may provide received signals to the transceivers 254a-254r, respectively. The transceivers 254a-254r may condition (e.g., filter, amplify, downconvert, and digitize) a respective received signal to obtain input samples. Each demodulator (DEMOD) in the transceivers 232a-232t may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH)) from the controller/processor 280. The transmit processor 264 may also generate reference symbols for a reference signal (e.g., the sounding reference signal (SRS)). The symbols from the transmit processor 264 may be precoded by a TX MIMO processor 266 if applicable, further processed by the modulators (MODs) in transceivers 254a-254r (e.g., for single-carrier frequency division multiplexing (SC-FDM), etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. The memories 242 and 282 may also interface with the controllers/processors 240 and 280, respectively. A scheduler 244 may schedule UEs for data transmission on the downlink and/or uplink.

In certain aspects of the present disclosure, the transceivers 232 and/or the transceivers 254 may be implemented with a low intermediate frequency (LIF) offset to improve receiver NF, as described in more detail herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The system bandwidth may also be partitioned into subbands. For example, a subband may cover multiple resource blocks (RBs).

### Example RF Transceiver

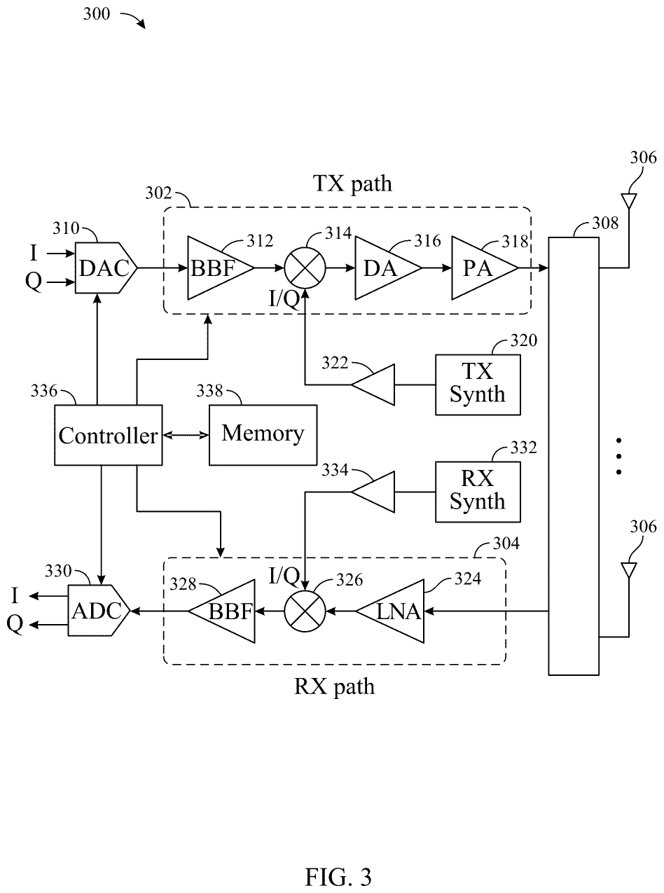

FIG. 3 is a block diagram of an example radio frequency (RF) transceiver circuit 300, in accordance with certain aspects of the present disclosure. The RF transceiver circuit 300 includes at least one transmit (TX) path 302 (also known as a “transmit chain”) for transmitting signals via one or more antennas 306 and at least one receive (RX) path 304 (also known as a “receive chain”) for receiving signals via the antennas 306. When the TX path 302 and the RX path 304 share an antenna 306, the paths may be connected with the antenna via an interface 308, which may include any of various suitable RF devices, such as a switch, a duplexer, a diplexer, a multiplexer, and the like.

Receiving in-phase (I) and/or quadrature (Q) baseband analog signals from a digital-to-analog converter (DAC) 310, the TX path 302 may include a baseband filter (BBF) 312, a mixer 314, a driver amplifier (DA) 316, and a power amplifier (PA) 318. The BBF 312, the mixer 314, the DA 316, and the PA 318 may be included in a radio frequency integrated circuit (RFIC). For certain aspects, the PA 318 may be external to the RFIC.

The BBF 312 filters the baseband signals received from the DAC 310, and the mixer 314 mixes the filtered baseband signals with a transmit local oscillator (LO) signal to convert the baseband signal of interest to a different frequency (e.g., upconvert from baseband to a radio frequency). This frequency-conversion process produces the sum and difference frequencies between the LO frequency and the frequencies of the baseband signal of interest. The sum and difference frequencies are referred to as the “beat frequencies.” The beat frequencies are typically in the RF range, such that the signals output by the mixer 314 are typically RF signals, which may be amplified by the DA 316 and/or by the PA 318 before transmission by the antenna(s) 306. While one mixer 314 is illustrated, several mixers may be used to upconvert the filtered baseband signals to one or more intermediate frequencies and to thereafter upconvert the intermediate frequency (IF) signals to a frequency for transmission.

The RX path 304 may include a low noise amplifier (LNA) 324, a mixer 326, and a baseband filter (BBF) 328. The LNA 324, the mixer 326, and the BBF 328 may be included in one or more RFICs, which may or may not be the same RFIC that includes the TX path components. RF signals received via the antenna(s) 306 may be amplified by the LNA 324, and the mixer 326 mixes the amplified RF signals with a receive local oscillator (LO) signal to convert the RF signal of interest to a different baseband frequency (e.g., downconvert). The baseband signals output by the mixer 326 may be filtered by the BBF 328 before being converted by an analog-to-digital converter (ADC) 330 to digital I and/or Q signals for digital signal processing.

Certain transceivers may employ frequency synthesizers with a variable-frequency oscillator (e.g., a voltage-controlled oscillator (VCO) or a digitally controlled oscillator (DCO)) to generate a stable, tunable LO with a particular tuning range. Thus, the transmit LO may be produced by a TX frequency synthesizer 320, which may be buffered or amplified by amplifier 322 before being mixed with the baseband signals in the mixer 314. Similarly, the receive LO may be produced by an RX frequency synthesizer 332, which may be buffered or amplified by amplifier 334 before being mixed with the RF signals in the mixer 326. For certain aspects, a single frequency synthesizer may be used for both the TX path 302 and the RX path 304. In certain aspects, the TX frequency synthesizer 320 and/or RX frequency synthesizer 332 may include a frequency divider/multiplier that is driven by an oscillator (e.g., a VCO) in the frequency synthesizer. In some aspects, the transceiver circuit 300 may be implemented with a LIF offset to improve receiver NF, as described in more detail herein.

A controller 336 (e.g., controller/processor 280 in FIG. 2) may direct the operation of the RF transceiver circuit 300A, such as transmitting signals via the TX path 302 and/or receiving signals via the RX path 304. The controller 336 may be a processor, a digital signal processor (DSP), an application-specific integrated circuit (ASIC), a field-programmable gate array (FPGA) or other programmable logic device (PLD), discrete gate or transistor logic, discrete hardware components, or any combination thereof. A memory 338 (e.g., memory 282 in FIG. 2) may store data and/or program codes for operating the RF transceiver circuit 300. The controller 336 and/or the memory 338 may include control logic (e.g., complementary metal-oxide-semiconductor (CMOS) logic).

While FIGS. 1-3 provide wireless communications as an example application in which certain aspects of the present disclosure may be implemented to facilitate understanding, certain aspects described herein may be used for any of various other suitable systems.

### Example Techniques for Dynamic Frequency Shifting to Improve Noise Figure

Some Fifth-Generation (5G) New Radio (NR) and Long-Term Evolution (LTE) downlink receivers may include a primary receive path and a secondary (diversity) receive path. The two paths may form a downlink pipe (DLP). In some implementations, a DLP may support reception from just one base station registered with one subscriber identity module (SIM) at a time. Some applications support reception on two SIMs from two carriers using the same DLP. Thus, a local oscillator arrangement may support both diversity reception for a single SIM and single path reception (e.g., non-diversity) with two SIMs where a primary receive path (PRx) would connect to a base station or carrier of the first SIM and the diversity receive path (DRx) would connect to a base station or carrier of a second SIM. Some multi-SIM (MSIM) operations involve using multiple DLPs for different SIMs, and some MSIM operations use only one DLP with a PRx and a DRx for different SIMs.

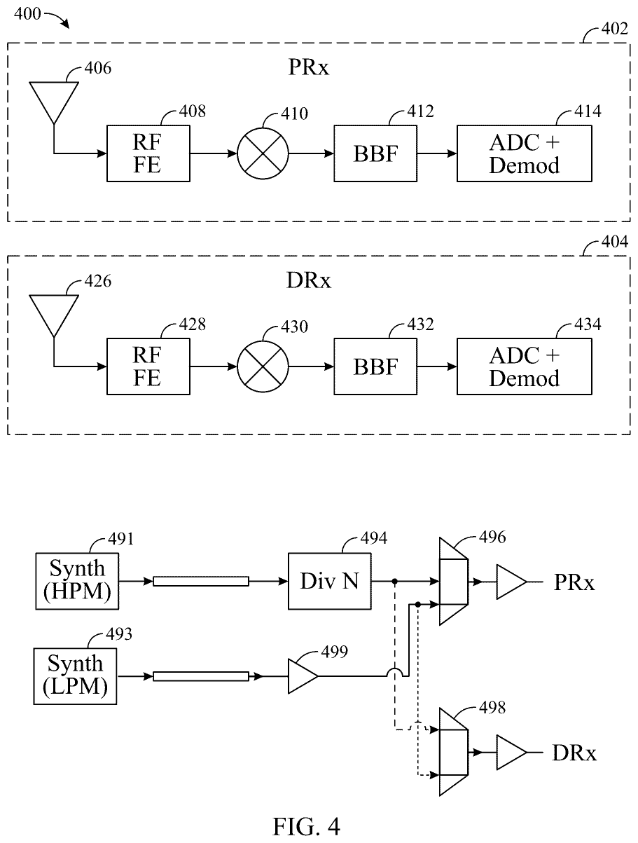

FIG. 4 illustrates a DLP 400 including a PRx 402 and DRx 404. The PRx 402 may include at least one antenna 406 coupled to a radio frequency (RF) front-end (FE) 408. The RF FE 408 may include a low-noise amplifier (LNA) (e.g., corresponding to LNA 324 of FIG. 3) for amplifying a signal received from the antenna. The amplified signal may be provided to a mixer 410 (e.g., corresponding to mixer 326 of FIG. 3) for down-conversion (e.g., signal down-conversion from RF to a baseband (BB) frequency) using a LO signal (not shown). The mixer 410 generates a BB signal that is provided to a BB filter (BBF) 412 (e.g., corresponding to the BBF 328 of FIG. 3) to generate a filtered signal that is then converted from an analog domain to the digital domain via an analog-to-digital converter (ADC) (e.g., corresponding to ADC 330 of FIG. 3) and demodulated using demodulation circuitry 414.

Similarly, the DRx 404 may include at least one antenna 426 coupled to an RF FE 428. The RF FE 428 may include an LNA for amplifying a signal received from the antenna. The amplified signal may be provided to a mixer 430 for down-conversion (e.g., from RF to a baseband (BB) frequency) using another LO signal. The mixer 430 generates a BB signal that is provided to a BBF 432 to generate a filtered signal that is then converted from the analog domain to the digital domain via an ADC and demodulated using demodulation circuitry 434.

In some aspects, multiple synthesizers 491, 493 may be used to generate local oscillator signals, such as a low-power mode (LPM) synthesizer 493 (e.g., implemented using a ring oscillator) and a high-performance mode (HPM) synthesizer 491 (e.g., implemented using an inductor-capacitor (LC) oscillator). The LO signal from synthesizer 491 may be provided to multiplexers 496, 498 (e.g., through a frequency divider 494, labeled “Div N”), and the LO signal from synthesizer 493 may be provided to multiplexers 496, 498 through a buffer 499. The multiplexers 496, 498 may be controlled to direct each LO signal to either the PRx or DRx (e.g., to either mixer 410 for the PRx 402 or mixer 430 for the DRx 404 for down-conversion). For some MSIM applications, the PRx may be associated with a first subscriber (sub1), and the DRx may be associated with a second subscriber (sub2) or vice versa.

In some cases, one receive path (e.g., PRx 402) may be used for traffic, and the other receive path (e.g., DRx 404) may be used for page reception or vice versa. In some cases the receive path used for traffic may use a high-performance synthesizer (e.g., synthesizer 491) with good phase noise. The receive path used for page reception may use the low-performance synthesizer (e.g., synthesizer 493) with poor phase noise to save the transceiver's power, area, and cost. In some other cases, when the signal-to-noise ratio (SNR) specification for traffic is low, traffic may use the low-performance synthesizer (e.g., synthesizer 493). In such cases, page reception may be performed through a high-performance synthesizer (e.g., synthesizer 491).

It may be difficult to achieve proper isolation between the PRx LO and DRx LO (e.g., an isolation of 55 dB), especially in small footprint implementations (e.g., small silicon area for an RF chip) and/or when supply and ground nodes (or circuits) are shared between the paths. Thus, when the LO frequencies for sub1 and sub2 are close (e.g., within a frequency difference threshold), degradation in the noise figure (NF) for sub1 and sub2 may occur.

Sub1 and sub2 may be operated using different bands, such as a low-band (LB), mid-band (MB), high-band (HB), ultra-high band North America (UNA), or New Radio unlicensed (NRU) band. If sub1 and sub2 are operating using the same band (e.g., HB), NF degradation may occur. For example, if sub1 and sub2 operate within HB and the LO frequencies of sub1 and sub2 are within a frequency difference threshold (e.g., 5 MHz), NF degradation (e.g., 1 dB NF degradation) may occur at the antenna ports for sub1 and sub2. If the LO frequencies for sub1 and sub2 are the same, a higher NF degradation (e.g., 16.8 dB NF degradation) may occur at the antenna ports, and even higher NF degradation (e.g., 36 dB NF degradation) may occur at the receiver input of the radio (e.g., chip including the mixers 430, 410).

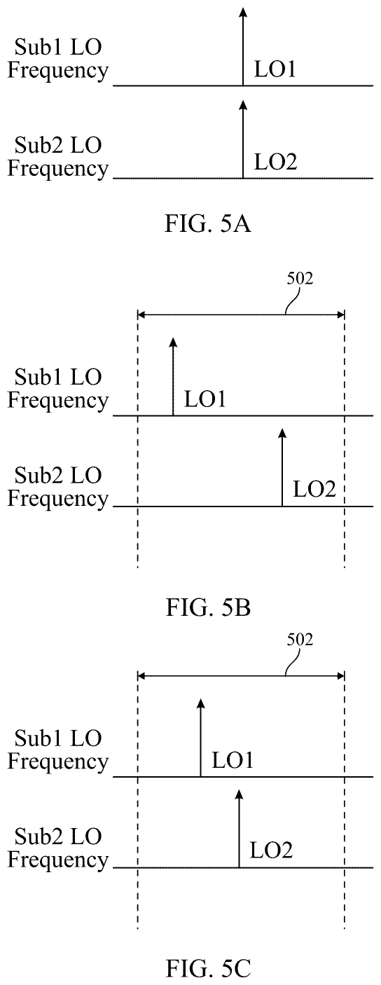

FIGS. 5A, 5B, and 5C illustrate example LO frequencies for sub1 and sub2. As shown in FIG. 5A, the sub1 LO (LO1) frequency may be equal to the sub2 LO (LO2) frequency, in which case high NF degradation may occur as described. Even though both sub1 and sub2 are assigned the same absolute radio-frequency channel number (ARFCN) and although Sub1 can receive a page for Sub2, through resource sharing in the frequency domain (e.g., through the concept of page sharing) the UE may decide to operate with two different LO signals operating at the same frequency, causing the NF degradation described herein. Page sharing refers to an implementation where a page of one subscriber is received by another subscriber, through resource sharing in frequency domain, using the same ARFCN. Page sharing may be implemented when both subscribers are using the same radio technology and the same operator (or network sharing operators).

In some aspects, a frequency difference threshold 502 may be identified. For example, if both sub1 and sub2 are operating in HB, a frequency difference threshold 502 of 5 MHz may be identified so that the NF degradation does not exceed 1 dB. As shown in FIG. 5B, if the difference between the LO1 and LO2 frequencies is less than the frequency difference threshold 502, high NF degradation may occur (e.g., greater than 1 dB). In some cases, as shown in FIG. 5C, the LO1 and LO2 frequencies may be within the frequency difference threshold 502, and the LO frequencies may cause a spur (e.g., beat frequency component) within the baseband channel bandwidth, causing issues with signal processing during reception. For example, this spur within the baseband channel bandwidth may occur if the following expression is true:

$$\vert m \times L 01 Frequency - n \times L 02 Frequency \vert < \frac{Signal Bandwidth}{2}$$

where m and n are positive integers and Signal Bandwidth is the RF System BW of Traffic/Paging Sub. Certain aspects of the present disclosure are directed towards dynamically determining and implementing a low intermediate frequency (LIF) offset for a subscriber to provide separation, that is greater than the frequency difference threshold, between the frequencies of the subscribers.

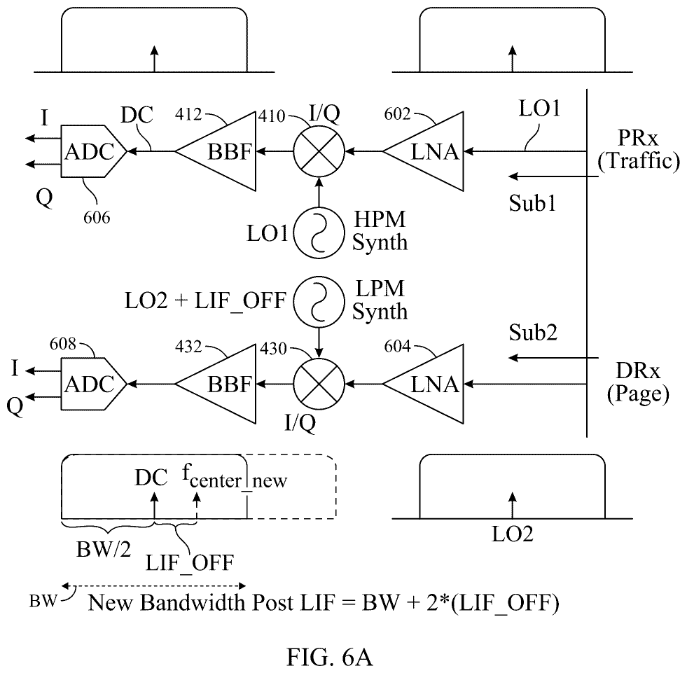

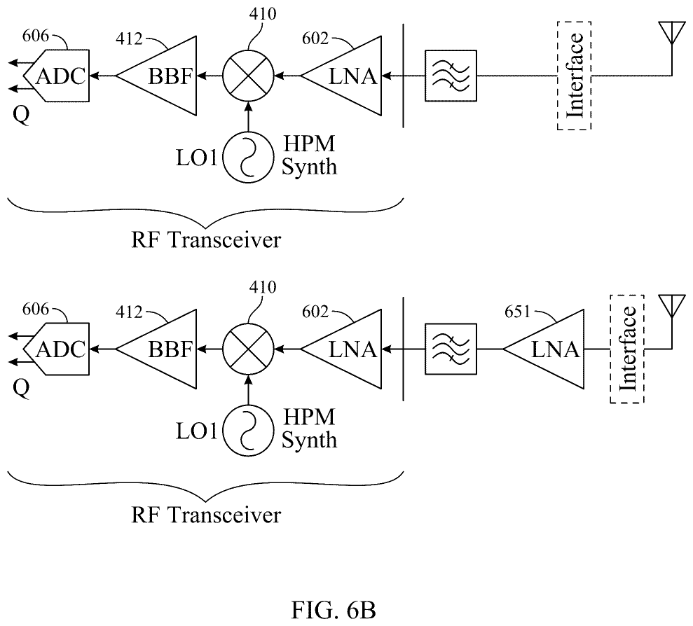

FIG. 6A illustrates example techniques for implementing a LIF offset (labeled “LIF_OFF”), in accordance with certain aspects of the present disclosure. As shown, traffic may be received by the PRx (e.g., the PRx 402) at the input of LNA 602 to generate an amplified signal that is downconverted by mixer 410. The input signal of the LNA 602 may have a bandwidth with a center frequency equal to the LO1 frequency. The downconverted signal may be filtered by a BBF 412 to generate a filtered signal. As shown, the center frequency of the filtered signal bandwidth may be at direct current (DC) (e.g., 0 hertz). The filtered signal is then converted from the analog domain to the digital domain via an ADC 606, as shown.

FIG. 6B illustrates a transceiver with an LNA inside or outside the transceiver. For example, the LNA 602 could be inside the RF transceiver as shown, or the LNA may be outside the transceiver. In some cases, amplification may be implemented with a cascade of two LNAs including an LNA 651 outside the transceiver followed by the LNA 602 inside the transceiver, as shown in FIG. 6B. The transceiver may be coupled to an antenna through an antenna interface, as shown.

Referring back to FIG. 6A, a page may be received by the DRx (e.g., the DRx 404) at the input of LNA 604 to generate an amplified signal that is downconverted by mixer 430. The input signal of the LNA 604 may have a bandwidth with a center frequency equal to the LO2 frequency. The downconverted signal may be filtered by a BBF 432 to generate a filtered signal. As shown, the center frequency of the filtered signal bandwidth (labeled “BW”) may be at DC. The filtered signal is then converted from the analog domain to the digital domain via an ADC 608, as shown.

In some aspects, a LIF offset (LIF_OFF) may be implemented. To implement the LIF offset, the LO2 frequency may be shifted by the LIF offset. Thus, the new frequency of the LO signal provided to mixer 430 may be equal to the LO2 frequency plus LIF_OFF, as shown. As a result, the filtered signal at the output of the BBF may have a new center frequency (f_{center_new}) that is equal to a no-offset center frequency (e.g., center frequency without applying the LIF offset, which is DC) plus the LIF offset, as shown. Thus, the new bandwidth post applying the LIF offset may be equal to:

$$BW + 2 \times LIF\_OFF$$

The filtered signal is then converted from the analog domain to the digital domain via an ADC 608, as shown.

In some aspects, a wireless device may determine whether to apply a LIF offset during the tuning of a subscriber by checking the active tune configuration (e.g., if present) of the other subscriber. For every subscriber tuning, the device may determine whether to apply a dynamic LIF offset by comparing the tune configuration for that subscriber with a previously configured tune configuration of the other subscriber. For instance, a controller (e.g., using an RF software driver) may check the separation between the LO frequency (e.g., tune configuration) of the first subscriber and the LO frequency of the second subscriber.

Suppose the separation is more than a frequency difference threshold (e.g., frequency difference threshold 502 described with respect to FIGS. 5B and 5C). In that case, no LIF offset may be implemented. A LIF offset may be implemented if the separation is less than the frequency difference threshold. The LIF offset to be applied may be determined per band group based on RF integrated circuit (RFIC) characterization. In other words, for each band group (e.g., LB, MB, HB), the frequency difference threshold may be determined so that the NF degradation does not exceed 1 dB. An RF driver may be used to run a sequence to determine if a spur (m×LO1 frequency n×LO2 frequency) will fall in the channel bandwidth in the baseband for either traffic or paging (e.g., in the baseband of sub1 or sub2). LIF offset may be applied if the spur will fall in the channel bandwidth. LIF offset application is then performed during the tuning of that subscriber (e.g., one of the subscribers) with digital configuration for de-rotation. For example, for de-rotation, the spectrum may be shifted back in the digital domain to compensate, or at least adjust, for the LIF offset applied in the analog domain.

### Example Techniques for Bandwidth Part (BWP) Dynamic Frequency Shifting

In some implementations (NR tech), a channel bandwidth (also referred to herein as an “operating bandwidth”) may be divided into multiple segments, which may be referred to as bandwidth parts (BWPs). A base station (BS) may select a specific BWP at a given time for data traffic communication. In some implementations, the BS may allocate up to four BWPs. BWPs may overlap in frequency in some cases.

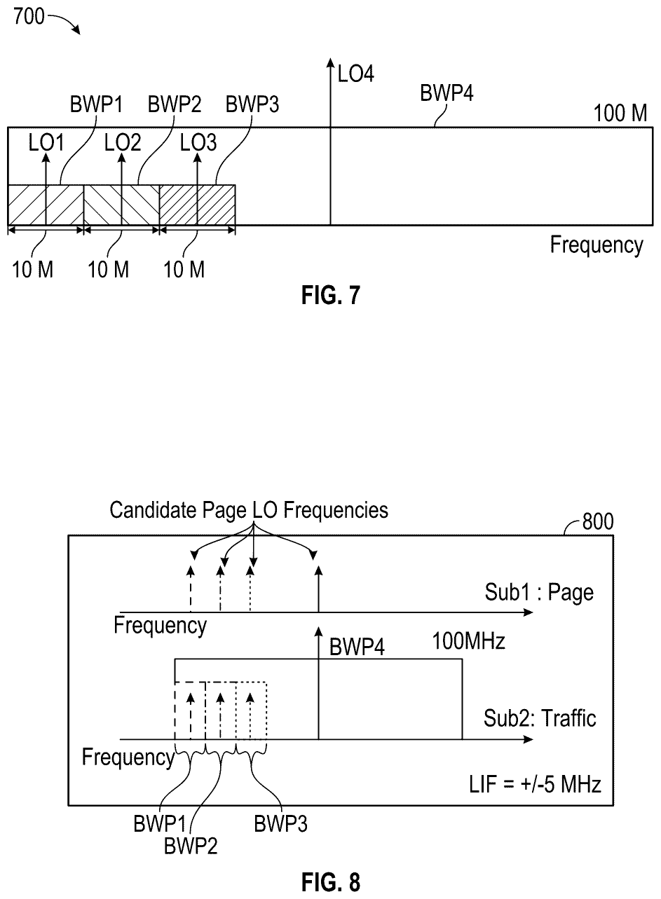

FIG. 7 is a graph 700 illustrating four BWPs (labeled “BWP1,” “BWP2,” “BWP3,” and “BWP4”) associated with different LO frequencies. As shown, the BWPs 1-3 may each have a 10 MHz bandwidth, and BWP4 may have a 100 MHz bandwidth, although any suitable bandwidths may be used. The bandwidths of BWPs 1-3 may be part of the bandwidth of BWP4, as shown. BWP4 may be referred to as a channel BWP (e.g., spans the frequency of the entire channel), and the other BWPs 1-3 may be included as part of the channel BWP. The BWPs may be associated with respective LO frequencies labeled LO1, LO2, LO3, and LO4. BWPs may be used for data traffic reception. That is, at any point in time, one of the BWPs may be used to receive data traffic. Although four BWPs are shown in FIG. 7, it is to be understood that there may be more or less than four BWPs, and that these BWPs may or may not overlap.

Due to die area and sharing of power supplies and ground nodes, when the LO frequencies of different subscribers for receiving page signals and data traffic overlap or are within a separation threshold, the noise figure (NF) may increase, making it difficult to decode the page signal and traffic BWP signal at sensitivity levels as described herein. Certain aspects are directed towards applying a LIF offset for the page LO frequency or the LO frequencies for the traffic BWPs to increase the frequency separation between the Page LO and traffic BWP LOs and improve page and traffic reception reliability. The LO frequency for the traffic or page may be moved dynamically to improve the noise figure.

FIG. 8 illustrates graphs 800 showing candidate page LO frequencies that may overlap with LO frequencies of BWPs 1-4. In other words, the LO frequency for page reception may be assigned to any of the candidate page LO frequencies that can overlap with the LO frequencies for BWP1, BWP2, BWP3, or BWP4. When the LO frequency of the page overlaps with the LO frequency of any of the BWPs, the noise figure of both the subscriber for reception of the page signal and the subscriber for reception of the traffic via a BWP increases.

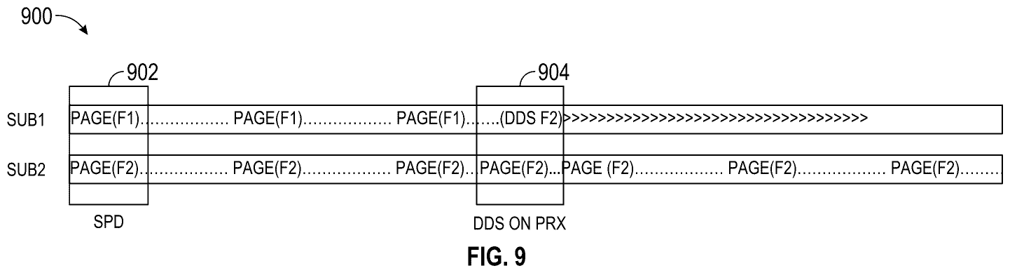

FIG. 9 is a diagram 900 illustrating the timing of page and data traffic receptions. As shown, initially in period 902, page decoding may occur on both subscribers (labeled “sub1” and “sub2”), which may be referred to as simultaneous page decode (SPD). As shown, the page receptions may be at two different LO frequencies, such as frequency f1 and frequency f2. At some point (e.g., in period 904), sub1 may be used for receiving data traffic using a dedicated data subscription (DDS). The data traffic may be received using the same LO frequency (f2) as being used by sub2 to receive page signals. For instance, sub1 may use the PRx chain for traffic decode. However, sub2 may continue to perform page decode periodically in the DRx chain. Thus, a conflict arises when sub1 decodes data traffic using the PRx chain and sub2 decodes page signals using the DRx chain using the same LO frequency. In some aspects, a LIF offset may be applied to the LO frequency for data traffic since the LO frequency for the data traffic is updated to use the same LO frequency as used for the page signal. That is, the LIF offset may be applied to the subscriber that updates its LO frequency to be the same as the LO frequency of the other subscriber. Thus, a LIF offset may be applied to one or more of the BWPs for sub1 traffic to reduce noise figure degradation. A physical (PHY) layer may provide information on LO frequencies and bandwidths (BWs) of the traffic BWPs and page, which may be used to calculate the LIF offset.

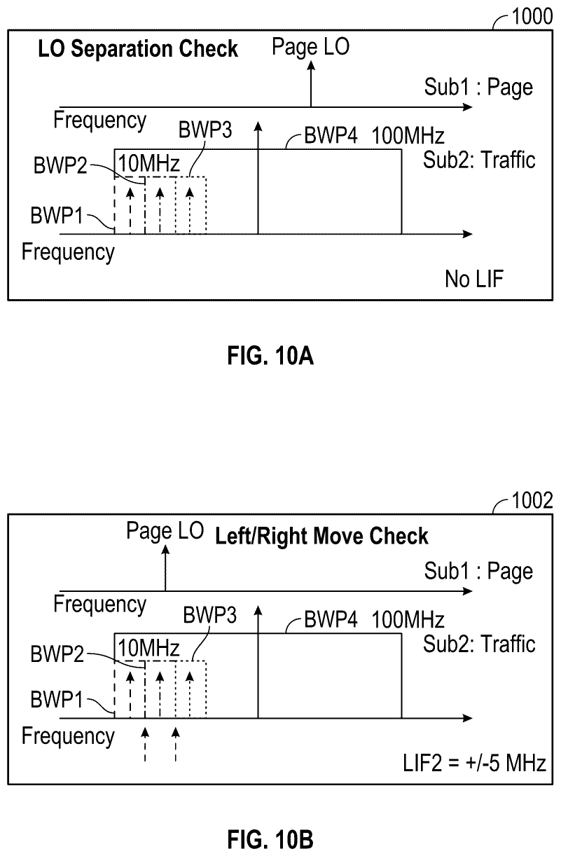

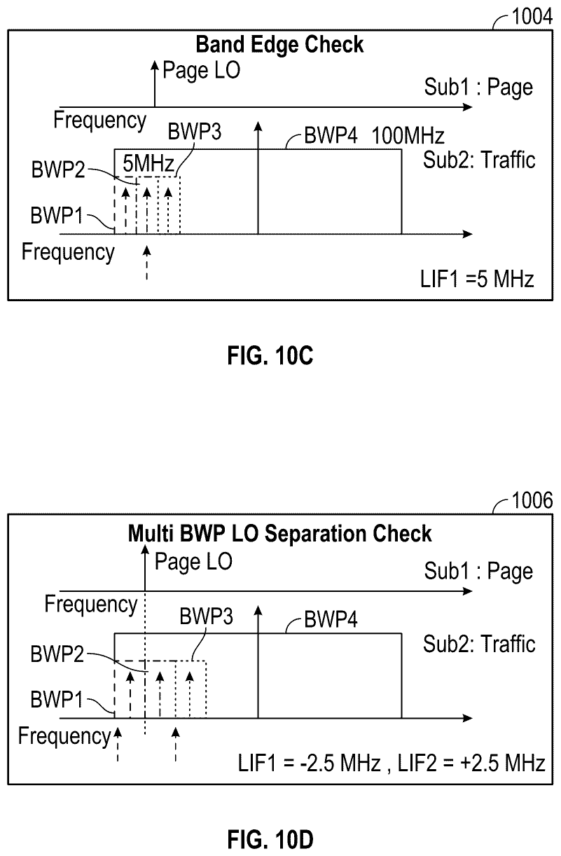

FIGS. 10A-10D illustrate respective graphs 1000, 1002, 1004, 1006 showing page and BWP LO frequencies and a LIF offset calculated for one or more of the BWP LO frequencies, in accordance with certain aspects of the present disclosure. As shown in graphs 1000 and 1002 of FIGS. 10A and 10B, the BWPs 1-3 may have BW of 10 MHZ, and BWP4 may have a BW of 100 MHz. As shown in FIG. 10A, if there is sufficient separation between the page LO frequency and the BWP LO frequencies, no LIF offset may be applied. As shown in FIG. 10B, the page LO frequency may overlap with the LO frequency for BWP2. In this case, either a positive mLIF (e.g., 5 MHz) or a negative mLIF (e.g., −5 MHz) may be applied to offset the LO frequency for BWP2, as shown.

As shown in graphs 1004 and 1006 of FIGS. 10C and 10D, the BWPs 1-3 may have BW of 5 MHz. As shown in FIG. 10C, the page LO frequency may overlap with the LO frequency for BWP1. In this case, a negative mLIF of 5 MHz may result in the LO frequency for BWP1 to be less than the lower edge of the operating band (e.g., for band n41, lower band edge is 2496). Thus, a positive mLIF may be applied for the LO frequency of BWP1, as shown.

As shown in FIG. 10D, the page LO frequency may be between the BWs of BWP1 and BWP2 and only a 2.5 MHz separation may exist between the page LO frequency and the LO frequencies of BWP1 and BWP2. Thus, a negative 2.5 MHz LIF offset (labeled “LIF1”) may be applied for BWP1 and a positive 2.5 MHz LIF offset (labeled “LIF2”) may be applied for BWP2.

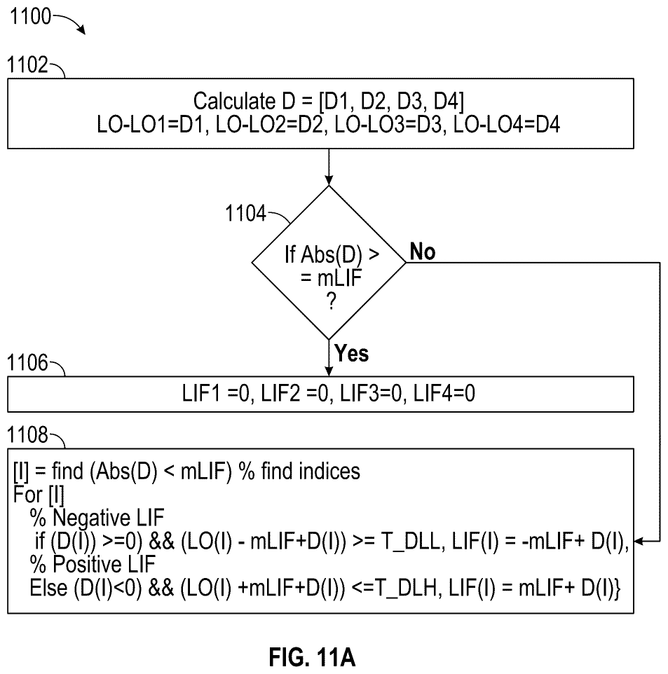

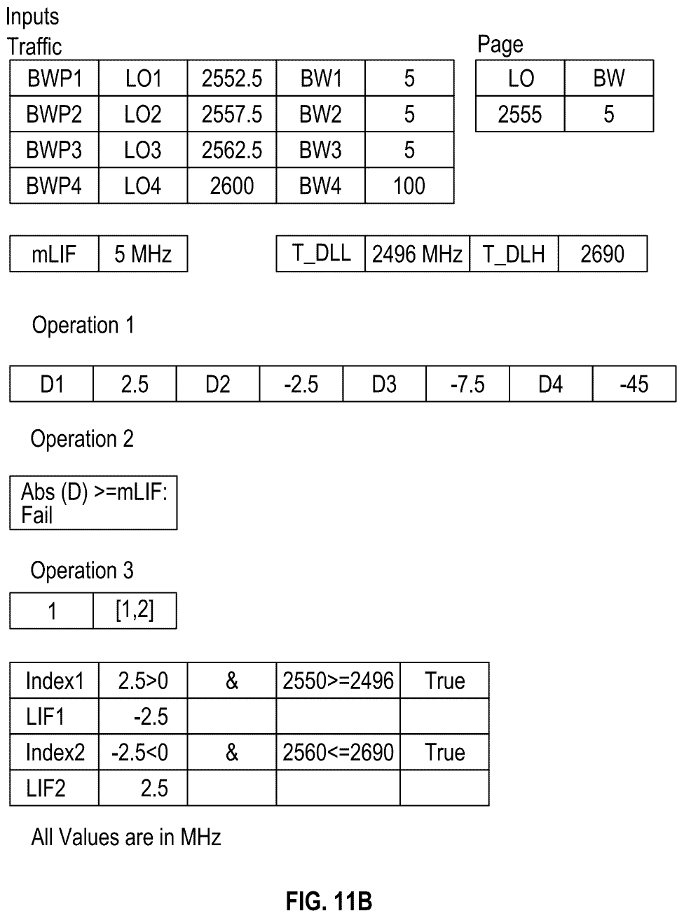

FIG. 11A is a flow diagram illustrating example operations 1100 for determining a LIF offset for traffic BWPs, in accordance with certain aspects of the present disclosure. The operations 1100 are used to calculate the LIF offsets for the traffic BWPs to meet a minimum LIF separation (mLIF, also referred to herein as a “a threshold frequency offset”) between the BWP LO frequencies and the page LO frequency. The mLIF may be selected based on the operating band (e.g., LB, MB, or HB), as described herein. The operations 1100 may be performed based on input bandwidths including the BW and LO frequency of the page signal, the BW (e.g., BW1, BW2, BW3, BW4) of the BWPs 1-4, respectively, LO frequencies (e.g., LO1, LO2, LO3, LO4) of the BWPs 1-4, respectively, and traffic band edges such as a traffic downlink low (T_DLL) frequency and a traffic downlink high (T_DLH) frequency. The T_DLL frequency may indicate the lower edge frequency of the operating band for data traffic and the T_DLH frequency may indicate the upper edge of the operating band for the data traffic, as described in more detail herein.

The operations 1100 may be performed, for example, by a processing device. At block 1102, the processing device may calculate a matrix D of values D1, D2, D3, and D4, wherein each of values D1-D4 indicates an LO frequency separation for each of the BWPs. That is, values D1-D4 indicate a frequency difference between a page LO frequency (labeled “LO”) and an associated BWP LO frequency (e.g., LO1, LO2, LO3, and LO4 for respective BWPs 1-4). D1 may be equal to LO-LO1, D2 may be equal to LO-LO2, and so on, as shown. At block 1104, the processing device may determine whether the absolute value of matrix D is greater than or equal to mLIF. In other words, the processing device may determine whether the absolute values of D1-D4 are greater than or equal mLIF. If so, LIFs 1-4 for respective BWPs 1-4 may be set to zero at block 1106, as shown. If not, at block 1108, the LIF offset for each of the BWPs that have a LO frequency separation less than mLIF may be determined. For example, the processing device may find indices [I] per expression:

$$[ I ] = find ( Abs ( D ) < mLIF )$$

That is, indices [I] correspond to one or more BWPs that have LO frequency separations that are less than mLIF. For indices [I], either a negative LIF offset or a positive LIF offset may be determined. For instance, if D(I) is greater than or equal to zero and LO(I)−mLIF+D(I) is greater than or equal to T_DLL, LIF(I) may be set to −mLIF+D(I) providing a negative LIF. Otherwise, if D(I) is less than zero and LO(I)+mLIF+D(I) is less than or equal to T_DLH, LIF(I) may be set to mLIF+D(I), providing a positive LIF. An example to facilitate understanding of operations 1100 is provided herein with respect to FIG. 11B.

FIG. 11B provides example frequency values for the BWPs and page reception shown in FIG. 10D, in accordance with certain aspects of the present disclosure. As shown, the processing device may receive as input values the LO frequencies (LO1-LO4) of respective BWPs 1-4 and BWs 1-4 of respective BWPs 1-4. The processing device may also receive the LO frequency of the page signal (labeled “LO”) and BW of the page signal (labeled “BW”). mLIF may be 5 MHz and T_DLL may be 2496 MHz and T_DLH may be 2690 MHz. At operation 1 (e.g., corresponding to block 1102 of FIG. 11A), D1, D2, D3, and D4 may be calculated as 2.5 MHz, −2.5 MHz, −7.5 MHz, and −45 MHz, respectively. At operation 2 (e.g., corresponding to block 1104), the processing device may determine that the frequency separations represented by matrix [D] are not meeting mLIF (e.g., D1 and D2 are more than mLIF of 5 MHZ). Thus, at operation 3 (e.g., corresponding to block 1108 of FIG. 11A), indices [I] may be set to [1, 2] corresponding to D1 and D2. For index 1, D(I) (e.g., D1) may be equal to 2.5 which is greater than zero, and [LO(I)−mLIF+D(I)] may be equal to 2550 which is greater than 2496 (T_DLL). Therefore, LIF1 (LIF offset for BWP1) may be set to −mLIF+D(I), which is −2.5 MHz. For index 2, D(I) (e.g., D2) may be equal to −2.5 which is less than zero, and [LO(I)+mLIF+D(I)] may be equal to 2560 which is less than 2690 (T_DLH). Therefore, LIF2 (LIF offset for BWP2) may be set to mLIF+D(I), which is 2.5 MHz.

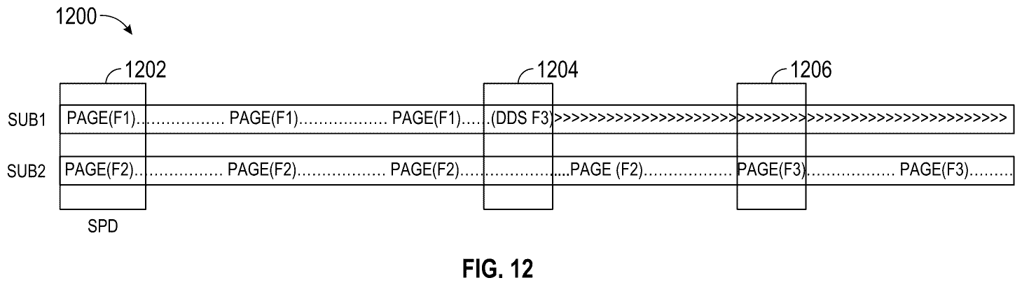

FIG. 12 is a diagram 1200 illustrating the timing of page and data traffic receptions. As shown, initially in period 1202, page decoding may occur on both subscribers (sub1 and sub2) using SPD. As shown, the page receptions may be at two different LO frequencies, such as frequency f1 and frequency f2. In period 1204, sub1 may be used to receive data traffic using DDS. In some cases, sub1 may use two receive chains (e.g., PRx and DRx) for traffic decode. The data traffic may be received using a different LO frequency (f3) which may not be the same LO frequency (f2) of sub2 used for page reception. Thus, a LIF offset may not be applied since the data and page receptions are using different frequencies. In period 1206, the page reception may switch from frequency f2 to frequency f3, and thus, the data reception using sub1 and page reception on sub2 may use the same frequency f3. Thus, a LIF offset may be calculated for the page signal and used to reduce noise figure degradation as described in more detail herein. As described, the LIF offset may be applied to the updated subscriber, which in this case is sub2 used for page reception as the frequency of the page reception on sub2 was updated to f3.

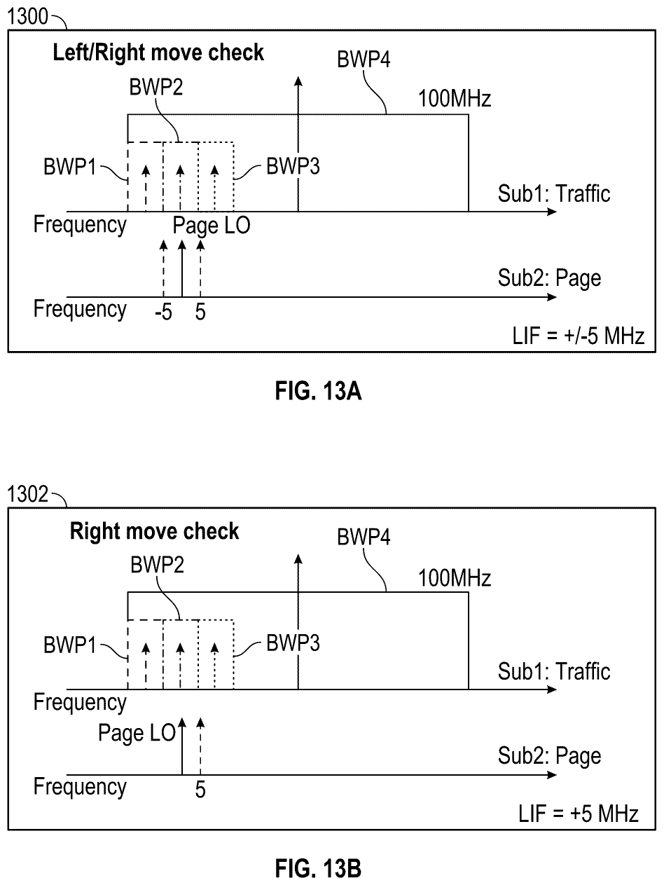

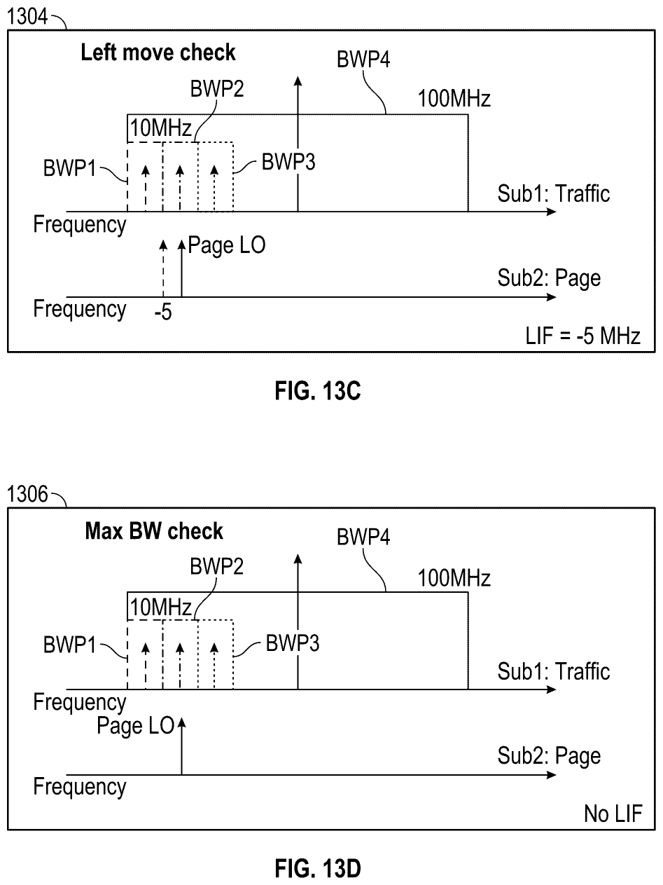

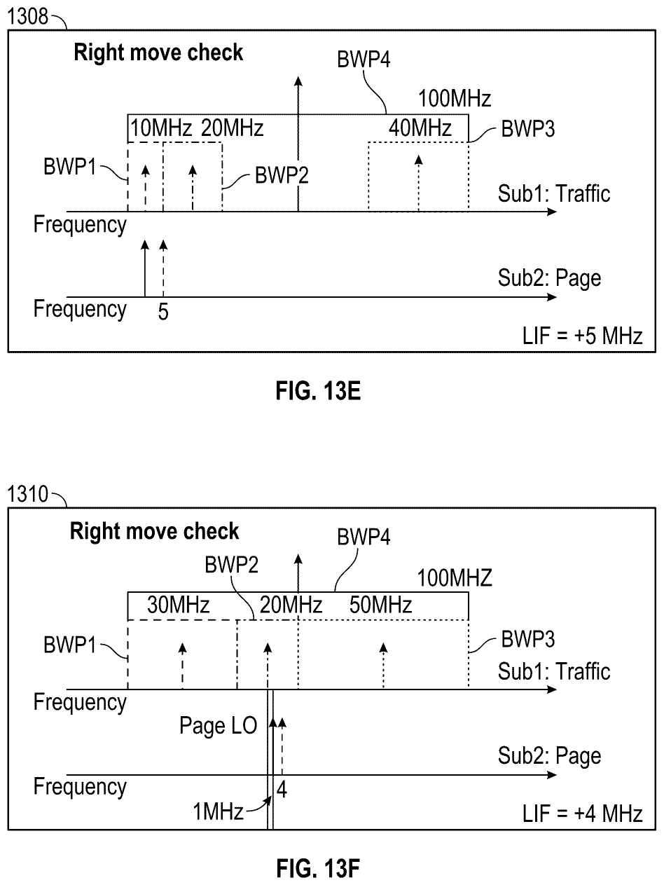

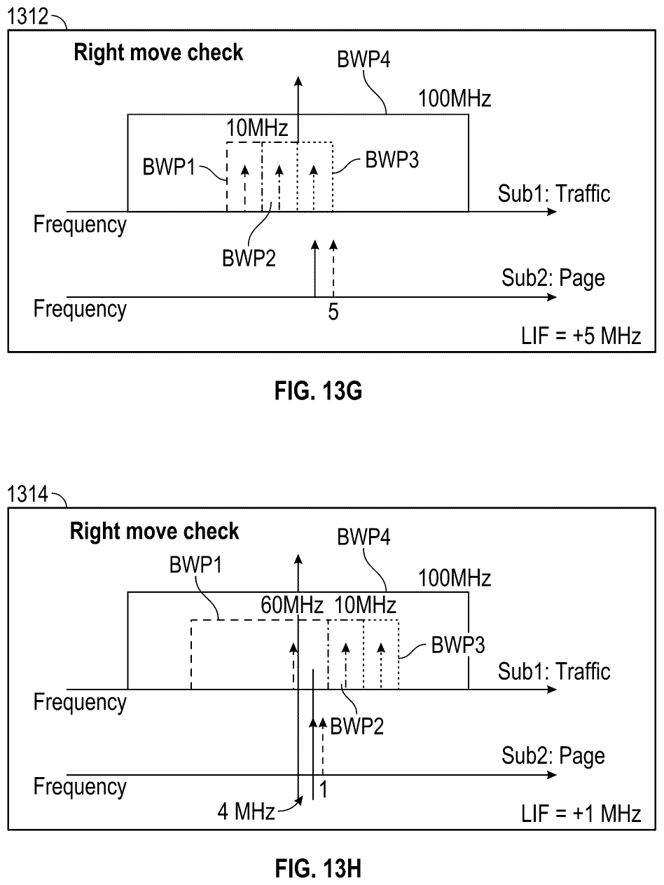

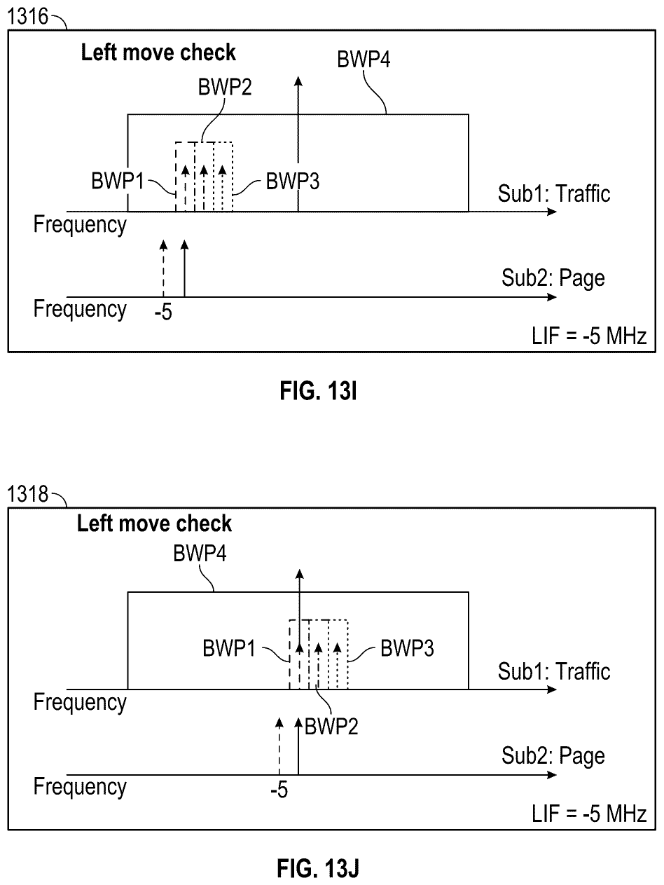

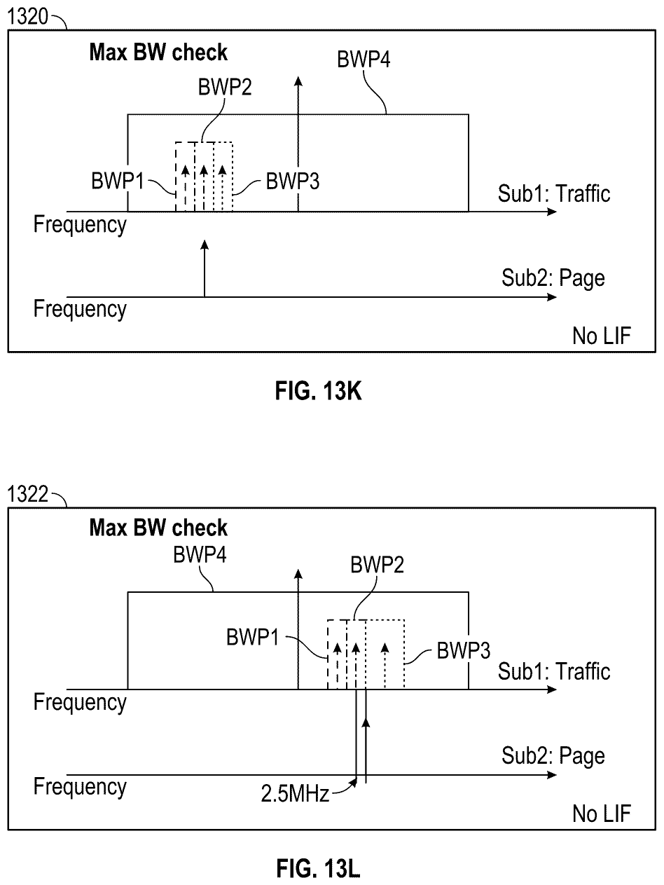

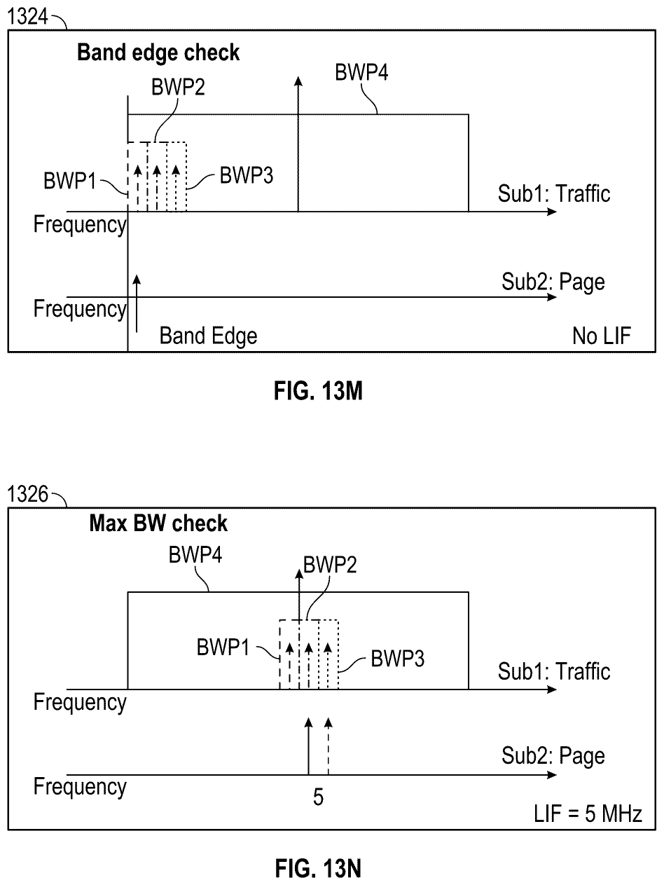

FIGS. 13A-13N are graphs illustrating page and BWP LO frequencies and LIF offset determined for a page LO frequency, in accordance with certain aspects of the present disclosure. As shown in FIGS. 13A-13D, the BWPs 1-3 may have a BW of 10 MHz and BWP4 may have a BW of 100 MHz. As shown in graphs 1300 of FIG. 13A, the page LO frequency may overlap with the LO frequency for BWP2. In this case, assuming mLIF is 5 MHZ, either a LIF offset of 5 MHz may be applied to the page LO frequency or a LIF offset of −5 MHz may be applied for the page LO frequency.

As shown in graph 1302 of FIG. 13B, the page LO frequency may overlap with the LO frequency for BWP2, where the BW of BWP2 overlaps with the BW of BWP1. If a LIF offset of −5 MHz is applied for the LO frequency of BWP2, then noise figure for BWP1 may be degraded by the page LO frequency (e.g., the adjusted page LO frequency may be within 5 MHz of BWP1 LO frequency). Thus, a positive LO offset of 5 MHz may be applied instead.

As shown in graph 1304 of FIG. 13C, the page LO frequency may overlap with the LO frequency for BWP2, where the BW of BWP2 overlaps with the BW of BWP3. If a LIF offset of positive 5 MHz is applied for the LO frequency of BWP2, then the noise figure for BWP3 may be degraded by the page LO frequency (e.g., the adjusted page LO frequency may be within 5 MHz of BWP3 LO frequency). Thus, a negative LO offset of −5 MHz may be applied instead.

As shown in graphs 1306 of FIG. 13D, BWP2 may overlap with both BWP1 and BWP3, and the page LO frequency may overlap with the LO frequency for BWP2. A negative LIF offset may degrade the noise figure for BWP1, and a positive LIF offset may degrade the noise figure for BWP3. In such scenarios, BWP with the highest bandwidth is given priority because higher BWs provide better throughputs. Thus, noise figure degradation to higher bandwidths may be avoided or at least reduced. In this case, the BWP with the largest BW is BWP4. Frequency separation between the page LO and BWP4 LO is greater than the separation threshold. Therefore, no LIF offset may be applied for the page in this case.

As shown in graph 1308 of FIG. 13E, BWP1 may have a BW of 10 MHz, BWP2 may have a BW of 20 MHz, BWP3 may have a BW of 40 MHz and BWP4 may have a BW of 100 MHz. The page LO frequency may overlap with the LO frequency of BWP1. A positive LIF offset of 5 MHz may be applied so that the adjusted LO frequency for the page falls between the BWs of BWP1 and BWP2, as shown. The frequency separation between the adjusted LO frequency and each of the traffic BWP1 and BWP2 is greater than or equal to the separation threshold.

As shown in graph 1310 of FIG. 13F, BWP1 may have a BW of 30 MHZ, BWP2 may have a BW of 20 MHz, BWP3 may have a BW of 50 MHz, and BWP4 may have a BW of 100 MHz. The frequency separation between the page LO frequency and the LO frequency for BWP2 may be 1 MHZ, and the page LO frequency may be greater than the LO frequency for BWP2. Thus, a LIF offset of positive 4 MHZ (e.g., mLIF of 5 MHz minus the frequency difference of 1 MHZ) may be applied for the page signal.

As shown in graph 1312 of FIG. 13G, BWPs 1-3 may have BWs of 10 MHZ, and BWP4 may have a BW of 100 MHz. The page LO frequency may overlap with the LO frequency of BWP3. Applying a negative LIF offset may result in the page LO frequency overlapping with the LO frequency of BWP4. Thus, a LIF offset of positive 5 MHz may be applied.

As shown in graph 1314 of FIG. 13H, BWP1 may have a BW of 60 MHZ, BWP2 may have a BW of 10 MHz, BWP3 may have a BW of 10 MHz, and BWP4 may have a BW of 100 MHz. The BW of BWP1 may overlap with BWs of BWP2-4, as shown. The page LO frequency may be 4 MHz greater than the LO frequency of BWP1. Thus, a LIF offset of 1 MHz may be applied for the page signal so that the frequency separation between the BWP1 LO frequency and the page LO frequency is equal to mLIF of 5 MHZ.

As shown in graph 1316 of FIG. 13I, BWPs 1-3 have BWs of 5 MHz, and BWP4 has a BW of 100 MHz. The page LO frequency may overlap with the LO frequency for BWP1. Applying a positive LIF offset may cause the noise figure for BWP2 to be degraded. Thus, a negative LIF offset of −5 MHz may be applied for the page LO frequency.

As shown in graph 1318 of FIG. 13J, BWPs 1-3 have BWs of 5 MHz, and BWP4 has a BW of 100 MHz. The page LO frequency may overlap with the LO frequency of both BWP1 and BWP4. Applying a positive LIF offset may cause the noise figure for BWP2 to be degraded. Thus, a negative LIF offset of −5 MHz may be applied for the page LO frequency.

As shown in graph 1320 of FIG. 13K, BWPs 1-3 have BWs of 5 MHz, and BWP4 has a BW of 100 MHz. The page LO frequency may overlap with the LO frequency of BWP2. A negative LIF offset may degrade the noise figure for BWP1 and a positive LIF offset may degrade the noise figure for BWP3. In such scenarios, BWP with the highest bandwidth may be given priority because higher BWs provide better throughputs. Thus, noise figure degradation to higher bandwidths may be avoided (or at least reduced). In this case, the BWP with the largest BW is BWP4. The frequency separation between the page LO and BWP4 LO is greater than the separation threshold. Thus, no LIF offset may be applied for the page signal in this case.

As shown in graph 1322 of FIG. 13L, BWPs 1-2 have BWs of 5 MHz, BWP3 has a BW of 10 MHz, and BWP4 has a BW of 100 MHz. The page LO frequency may be 2.5 MHz greater than the LO frequency of BWP2. A negative LIF offset may degrade the noise figure for BWP1 and a positive LIF offset may degrade the noise figure for BWP3. In such scenarios, BWP with highest bandwidth is given the priority. This is because higher BWs provide better throughputs, and hence, noise figure degradation to higher bandwidths may be avoided (or at least reduced). In this case, the BWP with the largest BW is BWP4. Frequency separation between the page LO and BWP4 LO is greater than the separation threshold. Thus, no LIF offset may be applied to the page signal in this case.

As shown in graph 1324 of FIG. 3M, BWPs 1-3 have BWs of 5 MHz, and BWP4 has a BW of 100 MHz. The page LO frequency may overlap with the LO frequency for BWP1. Applying a negative LIF offset may result in the page LO frequency being outside the operating band for the page reception. Moreover, a positive LIF offset may degrade the noise figure for BWP3. In such scenarios, BWP with the highest bandwidth may be given priority, as described herein. In this case, the BWP with the largest BW is BWP4 and the frequency separation between the page LO and BWP4 LO is greater than the separation threshold. Thus, no LIF offset may be applied to the page signal in this case.

As shown in graph 1326 of FIG. 13N, BWPs 1-3 have BWs of 5 MHZ, and BWP4 has a BW of 100 MHz. The page LO frequency may overlap with the LO frequency for BWP2. Applying a negative LIF offset of 5 MHz may degrade the noise figure for BWP1 and BWP4, and a positive LIF offset may degrade the noise figure for BWP3. In such scenarios, BWP with highest bandwidth is given priority, as described herein. In this case, the BWP with the largest BW is BWP4. The frequency separation between the page LO and BWP LO may be positive 2.5 MHz. Therefore, applying a LIF of positive 2.5 Mhz to the page may achieve the separation threshold rule between the page LO and traffic BWP4. However, the updated page LO breaks the separation threshold rule for BWP2 and BWP3. In such scenarios, mLIF of positive 5 MHz may be applied for the page signal resulting in breaking the separation threshold rule for only one BWP which is BWP3. Thus, when there are multiple conflicts, the algorithm sacrifices one of the BWPs to meet the minimum separation threshold for the BWP with the highest bandwidth and thus increasing throughput (e.g., providing the highest throughput).

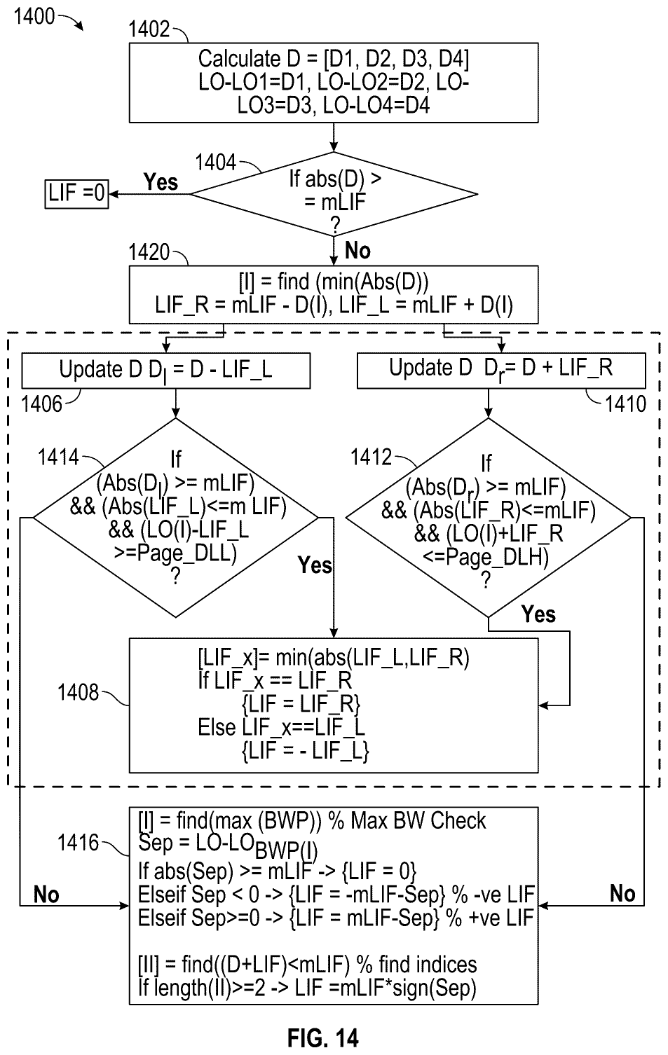

FIG. 14 is a flow diagram illustrating example operations 1400 for determining a LIF offset for the page signal, in accordance with certain aspects of the present disclosure. The operations 1400 may be performed, for example, by a processing device. The operations 1400 are used to calculate the LIF offset for the page LO frequency to meet mLIF between the BWP LO frequencies and the page LO frequency. As described, mLIF may be selected based on the operating band (e.g., LB, MB, or HB), as described herein.

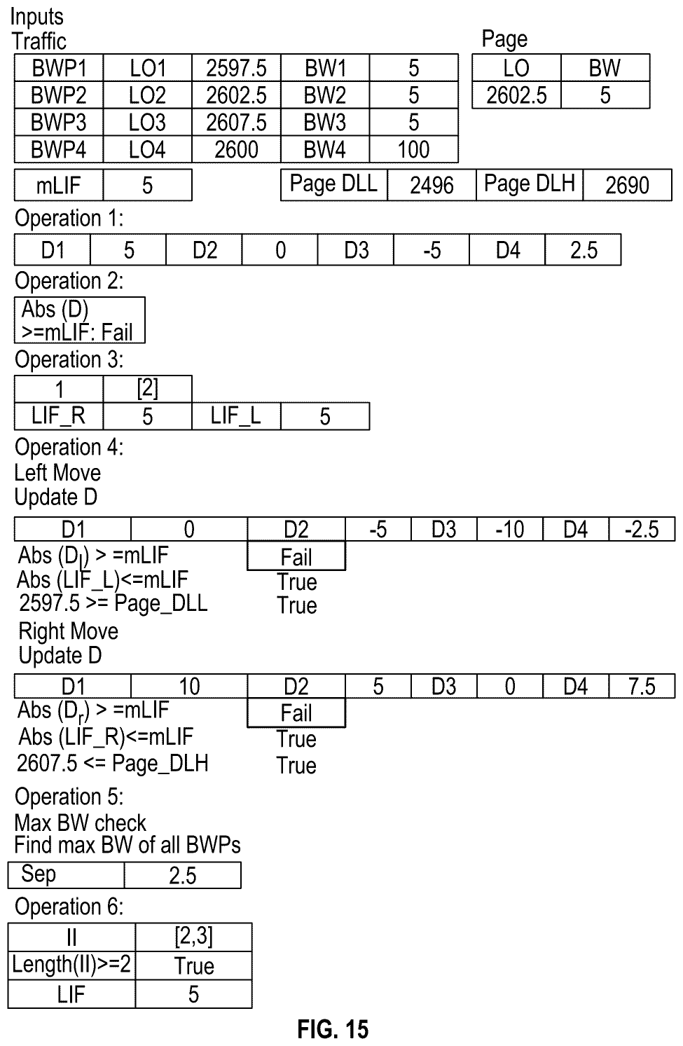

FIG. 15 provides example frequency values for the BWPs and page reception shown in FIG. 13N, in accordance with certain aspects of the present disclosure. To facilitate understanding, the operations 1400 of FIG. 14 will be explained using the example frequency values provided in FIG. 15.

At block 1402 of FIG. 14 corresponding to operation 1 of FIG. 15, the processing device may calculate a matrix D of values D1, D2, D3, and D4, where each of values D1-D4 indicates an LO frequency separation for each of the BWPs. That is, each of D1-D4 indicates a frequency difference between a page LO frequency (labeled “LO”) and an associated BWP LO frequency (e.g., LO1, LO2, LO3, and LO4 for respective BWPs 1-4). For example, as shown in FIG. 15, D1 may be equal to 5 MHz, D2 may be equal to 0 MHz, D3 may be equal to −5 MHz, and D4 may be equal to 2.5 MHz.

At block 1404 of FIG. 14 corresponding to operation 2 in FIG. 15, the processing device may determine whether the absolute value of each of D1, D2, D3, or D4 is greater than or equal to mLIF. If so, the LIF for the page LO frequency (labeled “LIF”) may be set to zero, as shown. If not, the LIF offset for the page LO frequency may be determined. For the example values provided in FIG. 15, the absolute values of D2 for BWP2 and D4 for BWP4 are less than mLIF, and therefore, a LIF offset will be determined. To determine the page LO frequency, both a positive LIF scenario (e.g., referred to as a right move LIF) and a negative LIF scenario (e.g., referred to as a left move LIF) may be considered. For example, at block 1420 of FIG. 14 corresponding to operation 3 in FIG. 15, the processing device may find indices [I] per expression:

$$[ I ] = find ( min ( Abs ( D ) ) )$$

That is, indices [I] may correspond to one or more BWPs that have the lowest LO frequency separation. For the example values provided in FIG. 15, the lowest LO frequency separate is provided by D2 for BWP2. Thus, I may be set to 2, as shown. Then, a right move LIF (LIF_R) and a left move LIF (LIF_L) may be calculated. LIF_L may be used to analyze a negative LIF offset and LIF_R may be used to analyze a positive LIF offset. LIF_R may be equal to mLIF-D(I) and LIF_L may be equal to mLIF+D(I). For the example values provided in FIG. 15, LIF_R may be equal to 5 MHZ (mLIF of 5 MHz minus D2 of 0 MHz) and LIF_L may be equal to 5 MHz (mLIF of 5 MHz plus D2 of 0 MHz). The operations at blocks 1406, 1414 for the left move scenario and the operations at blocks 1410, 1412 for the right move scenario, may be performed in parallel. The operations at blocks 1406, 1414 and operations at blocks 1410, 1412 correspond to operation 4 in FIG. 15.

At block 1406, the matrix D may be updated by subtracting LIF_L from each of D1-D4 to yield matrix D1. At block 1414, the processing device may determine whether the absolute value of the updated matrix Dₗ is greater than or equal to mLIF, whether the absolute value of LIF_L is less than or equal to mLIF, and whether LO(I)-LIF_L is greater than or equal to page_DLL. Page_DLL is the lower edge of the operating band for page reception. If so, then the operations at 1408 may be performed. Similarly, at block 1410, the matrix D may be updated by adding LIF_R to each of D1-D4 to yield matrix Dᵣ. At block 1412, the processing device may determine whether the absolute value of the updated matrix Dᵣ is greater than or equal to mLIF, whether the absolute value of LIF_R is less than or equal to mLIF, and whether LO(I)+LIF_R is less than or equal to Page_DLH. Page_DLH is the upper edge of the operating band for page reception. If so, then the operations at block 1408 may be performed.

At block 1408, a matrix [LIF_x] may be calculated as the min (abs(LIF_L, LIF_R)). In other words, [LIF_x] may include LIF_R or LIF_L, whichever is less (or both LIF_R and LIF_L if they are equal). If [LIF_x] includes LIF_R, then the LIF offset (labeled “LIF”) to be applied for the page reception may be equal to LIF_R. Otherwise, the LIF offset to be applied for the page reception may be equal to −LIF_L.

As shown in FIG. 15 for the left move scenario, LO(I) for BWP2 (e.g., LO2) minus LIF_L is equal to 2597.5 which is greater than or equal to page_DLL, LIF_L is less than or equal to mLIF, but the absolute value of D1 is not greater than or equal to mLIF. Similarly, for the right move scenario, LO(I) for BWP2 (e.g., LO2) plus LIF_R is equal to 2607.5 which is less than or equal to Page_DLH, LIF_R is less than or equal to mLIF, but the absolute value of Dᵣ is not greater than or equal to mLIF. Thus, the operations at block 1416 of FIG. 14, corresponding to operation 5 in FIG. 15, may be performed. At block 1416, the impact on the BWP having the highest BW may be considered, as described with respect to FIG. 13N.

At block 1416, the matrix [I] may be set to the BWP having the highest BW, such as BWP4 in the examples described herein. The frequency separation (labeled “Sep”) may be calculated as LO (e.g., LO frequency for the page reception) minus LO_{BWP(I)} (e.g., LO frequency of BWP having the highest BW). In the example provided in FIG. 15, Sep may be equal to 2.5 MHz. If the absolute value of Sep is greater than or equal to mLIF, then the LIF offset for the page reception may be set to zero. Otherwise, if Sep is less than zero, the LIF offset for the page reception may be set to −mLIF-Sep, and if Sep is greater than or equal to zero, the LIF offset for the page reception may be set to mLIF-Sep. In the example provided in FIG. 15, Sep (frequency separation of BWP4) is not greater than or equal to mLIF, but is greater than or equal to zero. Thus, the LIF offset for the page reception may be equal to 2.5 (mLIF-Sep).

With LIF calculated, the processing device may calculate a matrix [II] including indices associated with BWPs having a frequency separation (given by matrix D) plus LIF (e.g., LIF offset for the page reception) that is less than mLIF. For the example values provided in FIG. 15, BWPs 2 and 3 may each have a frequency separation plus LIF that is less than mLIF. If the length of matrix [II] (e.g., number of BWPs having a frequency separation plus LIF that is less than mLIF) is greater than or equal to 2, then LIF may be set to mLIF having the sign of Sep. For example, if Sep is a positive value, a positive mLIF may be applied. If Sep is a negative value, a negative mLIF may be applied. Thus, for the example values provided in FIG. 15, LIF may be set to 5 MHZ since Sep has a positive value (e.g., positive 2.5, as described).

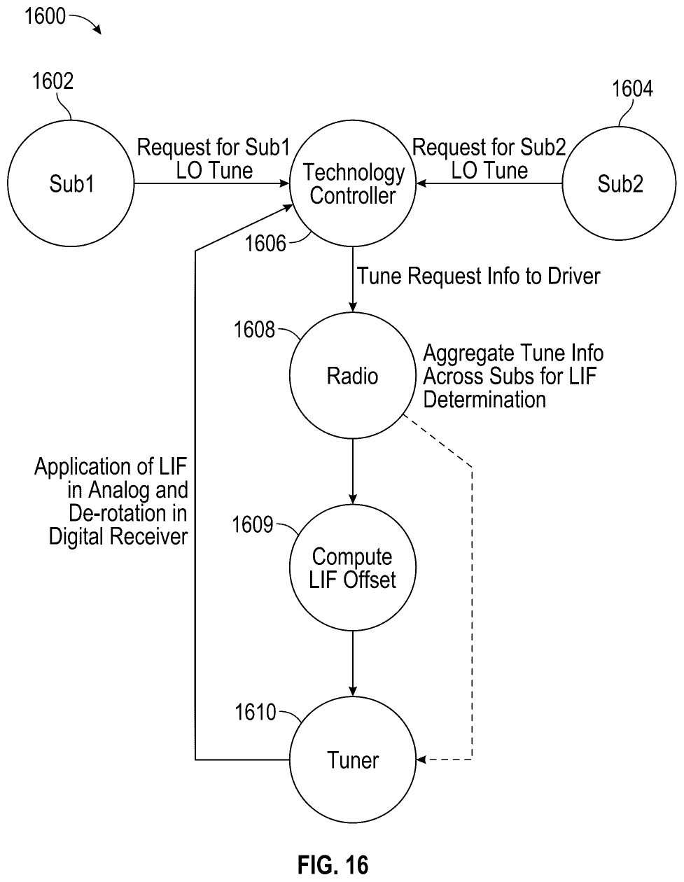

FIG. 16 illustrates example operations 1600 for the application of a LIF offset, in accordance with certain aspects of the present disclosure. At block 1602, a controller for a first subscriber (SUB1) may send, to a technology controller 1606 (e.g., controller of the radio access technology, such as Long-Term Evolution (LTE) or New Radio (NR)), a request for LO tuning for the first subscriber. For example, the controller may send tuning request information that may include a requested local oscillator frequency for the first subscriber. The tuning request information for the first subscriber may be sent to the radio 1608 and the requested tuning of the LO may be performed by an LO tuner 1610. At block 1604, a controller for a second subscriber (SUB2) may send to the technology controller 1606 a request for LO tuning for the second subscriber. The controller 1606 may send, to the radio 1608, the tuning request information for the second subscriber. The radio 1608 may aggregate (e.g., compare) the tuning information for the first subscriber and the second subscriber to determine whether a LIF offset is to be applied for the second subscriber (e.g., since the second subscriber's tuning request occurred later in time). At block 1609, the LIF offset to be applied to either the page LO frequency or the data traffic LO frequencies (e.g., for BWPs) may be calculated. The tuner 1610 may then tune the LO frequency for the second subscriber in the analog domain and configure the de-rotation in the digital domain for the second subscriber.

While some examples provided herein are described with respect to LTE and NR, any suitable radio access technology (RAT) or combination of RATs for SUB1 and SUB2 may be used. For example, SUB1 and SUB2 may be any of NR, LTE, wideband code division multiple access (WCDMA), global system for mobile (GSM), or CDMA 2000 (C2k), and in any combination between SUB1 and SUB2. Thus, controller 1606 may process requests from SUB1 and SUB2 across two different RATs.

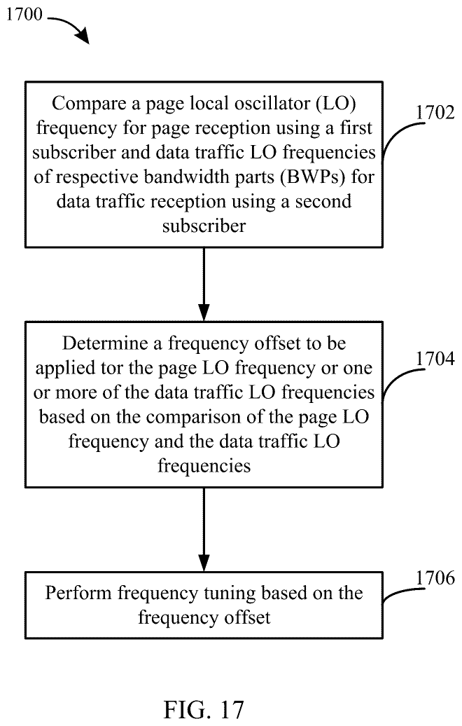

FIG. 17 is a flow diagram illustrating example operations 1700 for wireless communication, in accordance with certain aspects of the present disclosure. The operations 1700 may be performed, for example, by a wireless device, which may include receive paths (e.g., PRx 402 and DRx 404) and a controller such as the controller/processor 240 or controller/processor 280 of FIG. 2.

At block 1702, the wireless device may compare a page LO frequency for page reception using a first subscriber and data traffic LO frequencies of respective BWPs for data traffic reception using a second subscriber. At block 1704, the wireless device may determine a frequency offset to be applied to the page LO frequency or one or more of the data traffic LO frequencies based on the comparison of the page LO frequency and the data traffic LO frequencies. At block 1706, the wireless device may perform frequency tuning of the page LO frequency or the one or more of the data traffic LO frequencies based on the frequency offset. The wireless device may receive at least one of the page or the data traffic based on the tuned frequency.

In some aspects, the frequency offset may be determined for the one or more of the traffic LO frequencies based on an operating band (e.g., LB, MB, or HB) for the data traffic reception being updated to at least partially overlap with an operating band for the page reception. In some aspects, the frequency offset may be determined for the page reception based on an operating band (e.g., LB, MB, or HB) for the page reception being updated to at least partially overlap with a previously configured operating band for the page reception. In some aspects, determining the frequency offset may include determining whether to use a zero intermediate frequency (IF) or a low intermediate frequency (LIF).

In some aspects, comparing the page LO frequency and traffic LO frequencies may include determining whether a frequency difference between the page LO frequency and each of the data traffic LO frequencies is less than or equal to a threshold frequency offset (e.g., mLIF). In some aspects, the page reception or the data traffic reception may be associated with an operating band (e.g., for band n41, lower band edge is 2496). Comparing the page LO frequency and traffic LO frequencies may include determining whether an adjusted LO frequency for the page reception or the data traffic reception is within the operating band. In some aspects, the frequency offset may be determined for one or more of the traffic LO frequencies based on whether a frequency difference between the page LO frequency and each of one or more of the data traffic LO frequencies is equal to or greater than zero.

In some aspects, determining the frequency offset may include determining a negative move frequency offset (e.g., LIF_L as described with respect to FIG. 14) and a positive move frequency offset (e.g., LIF_R as described with respect to FIG. 14), and selecting, as the frequency offset to be applied to the page LO frequency, one of the negative move frequency offset and the positive move frequency offset having a lower absolute value. The one of the negative move frequency offset and the positive move frequency offset having the lower absolute value may be selected as the frequency offset based on at least one of: (1) whether each of the negative move frequency offset and the positive move frequency offset provides a frequency difference (e.g., as represented by matrices Dₗ and Dᵣ) between the page LO frequency and each of the data traffic LO frequencies that is less than or equal to a threshold frequency offset; (2) whether the negative move frequency offset and the positive move frequency offset are less than or equal to the threshold frequency offset; or (3) whether an adjusted page LO frequency determined using each of the negative move frequency offset and the positive move frequency offset is within an operating band associated with the page reception. In some aspects, the frequency offset may be determined based on a frequency difference between the page LO frequency and one of the data traffic LO frequencies corresponding to one of the BWPs having a highest bandwidth (e.g., BWP4 as described with respect to FIG. 14).

### Example Aspects

In addition to the various aspects described above, specific combinations of aspects are within the scope of the present disclosure, some of which are detailed below:

Aspect 1: A method for wireless communication, comprising: comparing a page local oscillator (LO) frequency for page reception using a first subscriber and data traffic LO frequencies of respective bandwidth parts (BWPs) for data traffic reception using a second subscriber; determining a frequency offset to be applied to the page LO frequency or one or more of the data traffic LO frequencies based on the comparison of the page LO frequency and the data traffic LO frequencies; and performing frequency tuning of the page LO frequency or the one or more of the data traffic LO frequencies based on the frequency offset.

Aspect 2: The method of Aspect 1, wherein the frequency offset is determined for the one or more of the data traffic LO frequencies based on an operating band for the data traffic reception being updated to at least partially overlap with a previously configured operating band for the page reception.

Aspect 3: The method of Aspect 1 or 2, wherein the frequency offset is determined for the page reception based on an operating band for the page reception being updated to at least partially overlap with a previously configured operating band for the data traffic reception.

Aspect 4: The method according to any of Aspects 1-3, wherein determining the frequency offset comprises determining whether to use a zero intermediate frequency (ZIF) or a low intermediate frequency (LIF).

Aspect 5: The method according to any of Aspects 1-4, wherein comparing the page LO frequency and the data traffic LO frequencies comprises determining whether a frequency difference between the page LO frequency and each of the data traffic LO frequencies is less than a threshold frequency offset.

Aspect 6: The method according to any of Aspects 1-5, wherein: the page reception or the data traffic reception is associated with an operating band; and comparing the page LO frequency and the data traffic LO frequencies comprises determining whether an adjusted LO frequency for the page reception or the data traffic reception is within the operating band.

Aspect 7: The method according to any of Aspects 1-6, wherein the frequency offset is determined for one or more of the data traffic LO frequencies based on whether a frequency difference between the page LO frequency and each of the one or more of the data traffic LO frequencies is less than a separation threshold.

Aspect 8: The method according to any of Aspects 1-7, wherein determining the frequency offset comprises: determining a negative move frequency offset and a positive move frequency offset; and selecting, as the frequency offset to be applied to the page LO frequency, one of the negative move frequency offset and the positive move frequency offset having a lower absolute value.

Aspect 9: The method of Aspect 8, wherein the one of the negative move frequency offset and the positive move frequency offset having the lower absolute value is selected as the frequency offset based on at least one of: whether each of the negative move frequency offset and the positive move frequency offset provides a frequency difference between an adjusted page LO frequency and each of the data traffic LO frequencies that is less than or equal to a threshold frequency offset; whether the negative move frequency offset and the positive move frequency offset are less than or equal to the threshold frequency offset; or whether an adjusted page LO frequency determined using each of the negative move frequency offset and the positive move frequency offset is within an operating band associated with the page reception.

Aspect 10: The method according to any of Aspects 1-9, wherein the frequency offset is determined based on a frequency difference between the page LO frequency and one of the data traffic LO frequencies corresponding to one of the BWPs having a highest bandwidth.

Aspect 11: An apparatus for wireless communication, comprising: one or more memories collectively storing executable instructions; and one or more processors coupled to the one or more memories, the one or more processors being collectively configured to execute the executable instructions to cause the apparatus to: compare a page local oscillator (LO) frequency for page reception using a first subscriber and data traffic LO frequencies of respective bandwidth parts (BWPs) for data traffic reception using a second subscriber; determine a frequency offset to be applied to the page LO frequency or one or more of the data traffic LO frequencies based on the comparison of the page LO frequency and the data traffic LO frequencies; and perform frequency tuning of the page LO frequency or the one or more of the data traffic LO frequencies based on the frequency offset.

Aspect 12: The apparatus of Aspect 11, wherein the one or more processors are collectively configured to execute the executable instructions to cause the apparatus to determine the frequency offset for the one or more of the data traffic LO frequencies based on an operating band for the data traffic reception being updated to at least partially overlap with an operating band for the page reception.

Aspect 13: The apparatus of Aspect 11 or 12, wherein the one or more processors are collectively configured to execute the executable instructions to cause the apparatus to determine the frequency offset for the page reception based on an operating band for the page reception being updated to at least partially overlap with a previously configured operating band for the data traffic reception.

Aspect 14: The apparatus according to any of Aspects 11-13, wherein, to determine the frequency offset, the one or more processors are collectively configured to execute the executable instructions to cause the apparatus to determine whether to use a zero intermediate frequency (ZIF) or a low intermediate frequency (LIF).

Aspect 15: The apparatus according to any of Aspects 11-14, wherein, to compare the page LO frequency and the data traffic LO frequencies, the one or more processors are collectively configured to execute the executable instructions to cause the apparatus to determine whether a frequency difference between the page LO frequency and each of the data traffic LO frequencies is less than a threshold frequency offset.

Aspect 16: The apparatus according to any of Aspects 11-15, wherein: the page reception or the data traffic reception is associated with an operating band; and to compare the page LO frequency and the data traffic LO frequencies, the one or more processors are collectively configured to execute the executable instructions to cause the apparatus to determine whether an adjusted LO frequency for the page reception or the data traffic reception is within the operating band.

Aspect 17: The apparatus according to any of Aspects 11-16, wherein the one or more processors are collectively configured to execute the executable instructions to cause the apparatus to determine the frequency offset for one or more of the data traffic LO frequencies based on whether a frequency difference between the page LO frequency and each of the one or more of the data traffic LO frequencies is less than a separation threshold.

Aspect 18: The apparatus according to any of Aspects 11-17, wherein, to determine the frequency offset, the one or more processors are collectively configured to execute the executable instructions to cause the apparatus to: determine a negative move frequency offset and a positive move frequency offset; and select, as the frequency offset to be applied to the page LO frequency, one of the negative move frequency offset and the positive move frequency offset having a lower absolute value.

Aspect 19: The apparatus of Aspect 18, wherein the one or more processors are collectively configured to execute the executable instructions to cause the apparatus to select, as the frequency offset, the one of the negative move frequency offset and the positive move frequency offset having the lower absolute value based on at least one of: whether each of the negative move frequency offset and the positive move frequency offset provides a frequency difference between an adjusted page LO frequency and each of the data traffic LO frequencies that is less than or equal to a threshold frequency offset; whether the negative move frequency offset and the positive move frequency offset are less than or equal to the threshold frequency offset; or whether an adjusted page LO frequency determined using each of the negative move frequency offset and the positive move frequency offset is within an operating band associated with the page reception.

Aspect 20: A non-transitory computer-readable medium having instruction stored thereon, that when executed by one or more processors, cause the one or more processors to: compare a page local oscillator (LO) frequency for page reception using a first subscriber and data traffic LO frequencies of respective bandwidth parts (BWPs) for data traffic reception using a second subscriber; determine a frequency offset to be applied to the page LO frequency or one or more of the data traffic LO frequencies based on the comparison of the page LO frequency and the data traffic LO frequencies; and perform frequency tuning of the page LO frequency or the one or more of the data traffic LO frequencies based on the frequency offset.

The above description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim.

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

1. A method for wireless communication, comprising:
comparing a page local oscillator (LO) frequency for page reception using a first subscriber and data traffic LO frequencies of respective bandwidth parts (BWPs) for data traffic reception using a second subscriber;
determining a frequency offset to be applied to the page LO frequency or one or more of the data traffic LO frequencies based on the comparison of the page LO frequency and the data traffic LO frequencies; and
performing frequency tuning of the page LO frequency or the one or more of the data traffic LO frequencies based on the frequency offset.

2. The method of claim 1, wherein the frequency offset is determined for the one or more of the data traffic LO frequencies based on an operating band for the data traffic reception being updated to at least partially overlap with a previously configured operating band for the page reception.

3. The method of claim 1, wherein the frequency offset is determined for the page reception based on an operating band for the page reception being updated to at least partially overlap with a previously configured operating band for the data traffic reception.

4. The method of claim 1, wherein determining the frequency offset comprises determining whether to use a zero intermediate frequency (ZIF) or a low intermediate frequency (LIF).

5. The method of claim 1, wherein comparing the page LO frequency and the data traffic LO frequencies comprises determining whether a frequency difference between the page LO frequency and each of the data traffic LO frequencies is less than a threshold frequency offset.

6. The method of claim 1, wherein:
the page reception or the data traffic reception is associated with an operating band; and
comparing the page LO frequency and the data traffic LO frequencies comprises determining whether an adjusted LO frequency for the page reception or the data traffic reception is within the operating band.

7. The method of claim 1, wherein the frequency offset is determined for one or more of the data traffic LO frequencies based on whether a frequency difference between the page LO frequency and each of the one or more of the data traffic LO frequencies is less than a separation threshold.

8. The method of claim 1, wherein determining the frequency offset comprises:
determining a negative move frequency offset and a positive move frequency offset; and
selecting, as the frequency offset to be applied to the page LO frequency, one of the negative move frequency offset and the positive move frequency offset having a lower absolute value.

9. The method of claim 8, wherein the one of the negative move frequency offset and the positive move frequency offset having the lower absolute value is selected as the frequency offset based on at least one of:
whether each of the negative move frequency offset and the positive move frequency offset provides a frequency difference between an adjusted page LO frequency and each of the data traffic LO frequencies that is less than or equal to a threshold frequency offset;
whether the negative move frequency offset and the positive move frequency offset are less than or equal to the threshold frequency offset; or
whether an adjusted page LO frequency determined using each of the negative move frequency offset and the positive move frequency offset is within an operating band associated with the page reception.

10. The method of claim 1, wherein the frequency offset is determined based on a frequency difference between the page LO frequency and one of the data traffic LO frequencies corresponding to one of the BWPs having a highest bandwidth.

11. An apparatus for wireless communication, comprising:
one or more memories collectively storing executable instructions; and
one or more processors coupled to the one or more memories, the one or more processors being collectively configured to execute the executable instructions to cause the apparatus to:
compare a page local oscillator (LO) frequency for page reception using a first subscriber and data traffic LO frequencies of respective bandwidth parts (BWPs) for data traffic reception using a second subscriber;
determine a frequency offset to be applied to the page LO frequency or one or more of the data traffic LO frequencies based on the comparison of the page LO frequency and the data traffic LO frequencies; and
perform frequency tuning of the page LO frequency or the one or more of the data traffic LO frequencies based on the frequency offset.

12. The apparatus of claim 11, wherein the one or more processors are collectively configured to execute the executable instructions to cause the apparatus to determine the frequency offset for the one or more of the data traffic LO frequencies based on an operating band for the data traffic reception being updated to at least partially overlap with a previously configured operating band for the page reception.

13. The apparatus of claim 11, wherein the one or more processors are collectively configured to execute the executable instructions to cause the apparatus to determine the frequency offset for the page reception based on an operating band for the page reception being updated to at least partially overlap with a previously configured operating band for the data traffic reception.

14. The apparatus of claim 11, wherein, to determine the frequency offset, the one or more processors are collectively configured to execute the executable instructions to cause the apparatus to determine whether to use a zero intermediate frequency (ZIF) or a low intermediate frequency (LIF).

15. The apparatus of claim 11, wherein, to compare the page LO frequency and the data traffic LO frequencies, the one or more processors are collectively configured to execute the executable instructions to cause the apparatus to determine whether a frequency difference between the page LO frequency and each of the data traffic LO frequencies is less than a threshold frequency offset.

16. The apparatus of claim 11, wherein:
the page reception or the data traffic reception is associated with an operating band; and
to compare the page LO frequency and the data traffic LO frequencies, the one or more processors are collectively configured to execute the executable instructions to cause the apparatus to determine whether an adjusted LO frequency for the page reception or the data traffic reception is within the operating band.

17. The apparatus of claim 11, wherein the one or more processors are collectively configured to execute the executable instructions to cause the apparatus to determine the frequency offset for one or more of the data traffic LO frequencies based on whether a frequency difference between the page LO frequency and each of the one or more of the data traffic LO frequencies is less than a separation threshold.

18. The apparatus of claim 11, wherein, to determine the frequency offset, the one or more processors are collectively configured to execute the executable instructions to cause the apparatus to:
determine a negative move frequency offset and a positive move frequency offset; and
select, as the frequency offset to be applied to the page LO frequency, one of the negative move frequency offset and the positive move frequency offset having a lower absolute value.

19. The apparatus of claim 18, wherein the one or more processors are collectively configured to execute the executable instructions to cause the apparatus to select, as the frequency offset, the one of the negative move frequency offset and the positive move frequency offset having the lower absolute value based on at least one of:
whether each of the negative move frequency offset and the positive move frequency offset provides a frequency difference between an adjusted page LO frequency and each of the data traffic LO frequencies that is less than or equal to a threshold frequency offset;
whether the negative move frequency offset and the positive move frequency offset are less than or equal to the threshold frequency offset; or
whether an adjusted page LO frequency determined using each of the negative move frequency offset and the positive move frequency offset is within an operating band associated with the page reception.

20. A non-transitory computer-readable medium having instruction stored thereon, that when executed by one or more processors, cause the one or more processors to:
compare a page local oscillator (LO) frequency for page reception using a first subscriber and data traffic LO frequencies of respective bandwidth parts (BWPs) for data traffic reception using a second subscriber;
determine a frequency offset to be applied to the page LO frequency or one or more of the data traffic LO frequencies based on the comparison of the page LO frequency and the data traffic LO frequencies; and
perform frequency tuning of the page LO frequency or the one or more of the data traffic LO frequencies based on the frequency offset.
